(19) United States
(12) Patent Application Publication
(10) Pub. No.: US 2024/0153071 A1
(43) Pub. Date: May 9, 2024

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventor: YOSHIKO IIDA, Kanagawa (JP)

(21) Appl. No.: 18/467,787

(22) Filed: Sep. 15, 2023

(30) Foreign Application Priority Data
Nov. 4, 2022 (JP) 2022-177470

(51) Int. Cl. G06T 7/00; G06T 7/33; G06T 7/40

(52) U.S. Cl. CPC G06T 7/001; G06T 7/0008; G06T 7/337; G06T 7/40; G06T 2200/24; G06T 2207/20021; G06T 2207/20092; G06T 2207/30108

(57) ABSTRACT

A texture pattern is reduced from an image easily. An image processing apparatus matches the spatial frequency component of a first texture pattern taken to be a reference with the spatial frequency component of a second texture pattern included in a target image and reduces the spatial frequency component of the second texture pattern included in the target image based on results of the matching.

### CROSS-REFERENCE TO PRIORITY APPLICATION

This application claims the benefit of Japanese Patent Application No. 2022-177470, filed Nov. 4, 2022, which is hereby incorporated by reference herein in its entirety.

### BACKGROUND

### Field of the Invention

The present invention relates to an image processing technique for reducing a texture pattern included in an image.

### Description of the Related Art

There is a technique to remove a periodic texture pattern (in the following, simply referred to as “texture pattern”) included in an image. Japanese Patent Laid-Open No. 2003-150954 has disclosed a technique to remove a texture pattern existing as noise from an image by using information indicating a spatial frequency component distribution in the image and a one-dimensional filter.

### SUMMARY

The image processing apparatus according to the present invention includes: one or more processors; and one or more memories storing one or more programs configured to be executed by the one or more processors, the one or more programs including instructions for: matching a spatial frequency component of a first texture pattern taken to be a reference with a spatial frequency component of a second texture pattern included in a target image; and reducing the spatial frequency component of the second texture pattern included in the target image based on results of the matching.

Further features of the present invention will become apparent from the following description of exemplary embodiments with reference to the attached drawings.

### BRIEF DESCRIPTION OF THE DRAWINGS

FIG. 1 is a block diagram showing one example of a configuration of an inspection system according to Embodiment 1;

FIG. 2 is a block diagram showing one example of a function configuration of an image processing apparatus according to Embodiment 1;

FIG. 3 is a block diagram showing one example of a hardware configuration of the image processing apparatus according to Embodiment 1;

FIG. 4 is a block diagram showing one example of a function configuration of an inspection apparatus according to Embodiment 1;

FIG. 5 is a flowchart showing one example of a processing flow of the image processing apparatus according to Embodiment 1;

FIG. 6A is a flowchart showing one example of a processing flow of a matching unit according to Embodiment 1;

FIG. 6B is a flowchart showing one example of a processing flow in processing at S520 shown in FIG. 5;

FIG. 6C is a flowchart showing one example of a processing flow in processing at S530 shown in FIG. 5;

FIG. 7A to FIG. 7F are each a diagram for explaining a spatial frequency mask and a corrected spatial frequency mask according to Embodiment 1;

FIG. 8A and FIG. 8B are each a diagram showing one example of a GUI that the image processing apparatus according to Embodiment 1 causes a display device to display;

FIG. 9 is a diagram showing one example of a GUI for parameter adjustment according to Embodiment 1;

FIG. 10 is a flowchart showing one example of a processing flow of the inspection apparatus according to Embodiment 1;

FIG. 11 is a diagram showing one example of a display image that the inspection apparatus according to Embodiment 1 causes a display device to display;

FIG. 12 is a block diagram showing one example of a function configuration of an image processing apparatus according to Embodiment 2;

FIG. 13 is a flowchart showing one example of a processing flow of a matching unit according to Embodiment 2;

FIG. 14 is a block diagram showing one example of a function configuration of an image processing apparatus according to Embodiment 3;

FIG. 15 is a flowchart showing one example of a processing flow of the image processing apparatus according to Embodiment 3;

FIG. 16A is a flowchart showing one example of a processing flow of a matching unit according to Embodiment 3;

FIG. 16B is a flowchart showing one example of a processing flow in processing at S1520 shown in FIG. 15;

FIG. 17 is a block diagram showing one example of a function configuration of an image processing apparatus according to Embodiment 4;

FIG. 18 is a flowchart showing one example of a processing flow of the image processing apparatus according to Embodiment 4;

FIG. 19A is a flowchart showing one example of a processing flow of a matching unit according to Embodiment 4;

FIG. 19B is a flowchart showing one example of a processing flow in processing at S1820 shown in FIG. 18;

FIG. 19C is a flowchart showing one example of a processing flow in processing at S1830 shown in FIG. 18;

FIG. 20 is an explanatory diagram for explaining one example of area division processing according to Embodiment 4;

FIG. 21A to FIG. 21C are each a diagram showing one example of a spatial frequency mask according to Embodiment 4;

FIG. 22 is a correspondence table in which a product model number and a condition of texture pattern reduction processing are associated with each other according to Embodiment 4;

FIG. 23 is a block diagram showing one example of a function configuration of an image processing apparatus according to Embodiment 5; and

FIG. 24 is a flowchart showing one example of a processing flow of the image processing apparatus according to Embodiment 5.

### DESCRIPTION OF THE EMBODIMENTS

Hereafter, with reference to the attached drawings, the present invention is explained in detail in accordance with preferred embodiments. Configurations shown in the following embodiments are merely exemplary and the present invention is not limited to the configurations shown schematically.

With the technique disclosed in Japanese Patent Laid-Open No. 2003-150954, in a case where there is a misalignment between the direction of a texture pattern included in an image and a predetermined direction, it is necessary to adjust the band of a one-dimensional filter in accordance with the misalignment amount. An object of the present invention is to provide processing for easily reducing a texture pattern from an image without the need to perform complicated work, such as adjustment of the band of a one-dimensional filter, even in a case where there are variations in the direction of the texture pattern.

### Embodiment 1

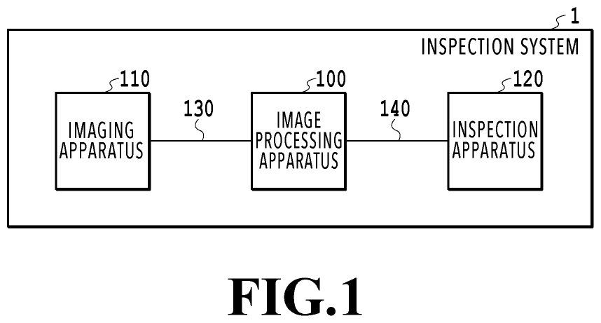

With reference to FIG. 1 to FIG. 11, an image processing apparatus 100 and an inspection apparatus 120 according to Embodiment 1 are explained. FIG. 1 is a block diagram showing one example of the configuration of an inspection system 1 including the image processing apparatus 100 and the inspection apparatus 120 according to Embodiment 1. The inspection system 1 comprises the image processing apparatus 100, an imaging apparatus 110, and the inspection apparatus 120. The image processing apparatus 100 is connected with the imaging apparatus 110 so as to be capable of communication with each other via a communication line 130 by wired connection, such as a dedicated line or LAN (Local Area Network), or wireless connection, such as wireless LAN. Further, the image processing apparatus 100 is connected with the inspection apparatus 120 so as to be capable of communication with each other via a communication line 140 by wired connection, such as a dedicated line or LAN, or wireless connection, such as wireless LAN. The imaging apparatus 110 includes a digital still camera and the like, and captures the image of an inspection target, such as a product during manufacture or a manufactured product, and outputs data (in the following, called “captured image data”) of the captured image obtained by image capturing.

The image processing apparatus 100 obtains the captured image data that is output by the imaging apparatus 110 as data (in the following, described as “target image data”) of a processing-target image (in the following, called “target image”). The source from which target image data is obtained is not limited to the imaging apparatus 110 and it may also be possible for the image processing apparatus 100 to obtain captured image data by reading it from a storage device, not shown schematically in FIG. 1, which in advance stores the captured image data. The image processing apparatus 100 performs reduction processing of a texture pattern included in the target image for the obtained target image data and outputs data (in the following, called “reduced target image data”) of the image (in the following, called “reduced target image”) for which the reduction processing has been performed.

The inspection apparatus 120 inspects the outer appearance of a product on the surface or the like of which a texture pattern is formed. In a case where a texture pattern is formed on the surface or the like of a product in a post-process, such as the final process in the manufacture process of the product, there is a possibility that the angle of the texture pattern changes though the texture pattern remains the same by the influence of a slight inclination or the like of the produce at the time of the formation of the texture pattern. In the inspection of the product outer appearance, in a case where it is not possible to reduce the texture pattern from the target image due to the influence of the misalignment of the angle of the texture pattern that is formed on the surface or the like of the product, it may happen sometimes that it is erroneously determined there is a defect in the product due to the texture pattern that remains in the target image.

In the inspection system 1 according to the present invention, the inspection apparatus 120 obtains reduced target image data that the image processing apparatus 100 outputs via the communication line 140 and inspects the state of the texture pattern formed in the product based on the reduced target image. Due to this, even in a case where there is an inclination in the product at the time of the formation of the texture pattern, it is possible for the inspection apparatus 120 to perform inspection with high accuracy in the inspection of the product outer appearance. The source from which reduced target image data is obtained is not limited to the imaging apparatus 110 and it may also be possible for the inspection apparatus 120 to obtain reduced target image data by reading it from a storage device, not shown schematically in FIG. 1, which in advance stores the reduced target image data.

### <Function Configuration of Image Processing Apparatus>

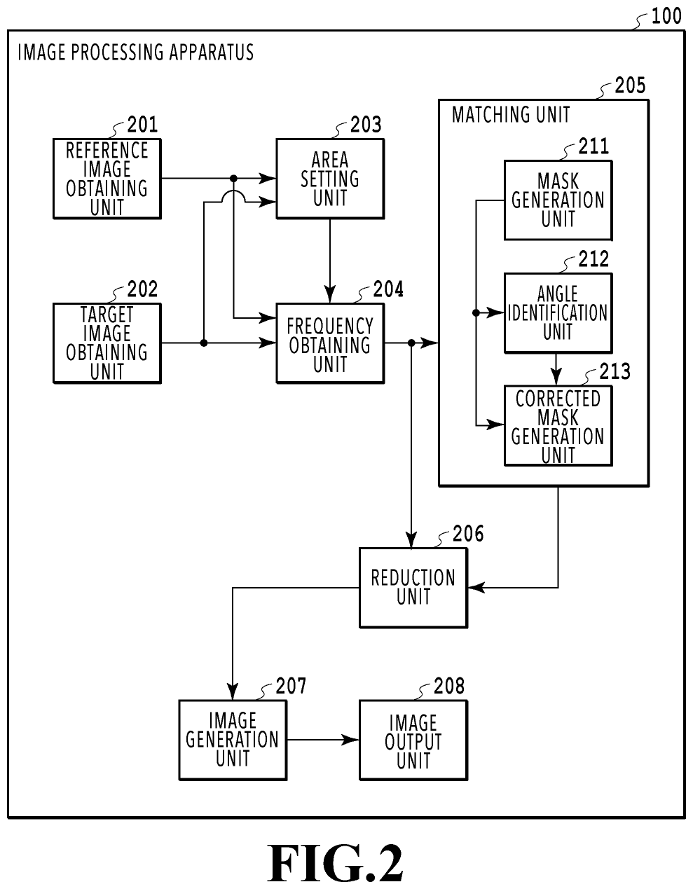

FIG. 2 is a block diagram showing one example of the function configuration of the image processing apparatus 100 according to Embodiment 1. The image processing apparatus 100 comprises a reference image obtaining unit 201, a target image obtaining unit 202, an area setting unit 203, a frequency obtaining unit 204, a matching unit 205, a reduction unit 206, an image generation unit 207, and an image output unit 208. Further, the matching unit 205 comprises a mask generation unit 211, an angle identification unit 212, and a corrected mask generation unit 213. The processing of each unit that the image processing apparatus 100 comprises is performed by hardware, such as an ASIC (Application Specific Integrated Circuit) or the like, which is incorporated in the image processing apparatus 100. The processing may be performed by hardware, such as an FPGA (Field Programmable Gate Array). Further, the processing may be performed by software using a memory, such as a RAM (Random Access Memory), and a processor, such as a CPU (Central Processor Unit). Details of the processing of each unit that the image processing apparatus 100 comprises as the function configuration will be described later.

### <Hardware Configuration of Image Processing Apparatus>

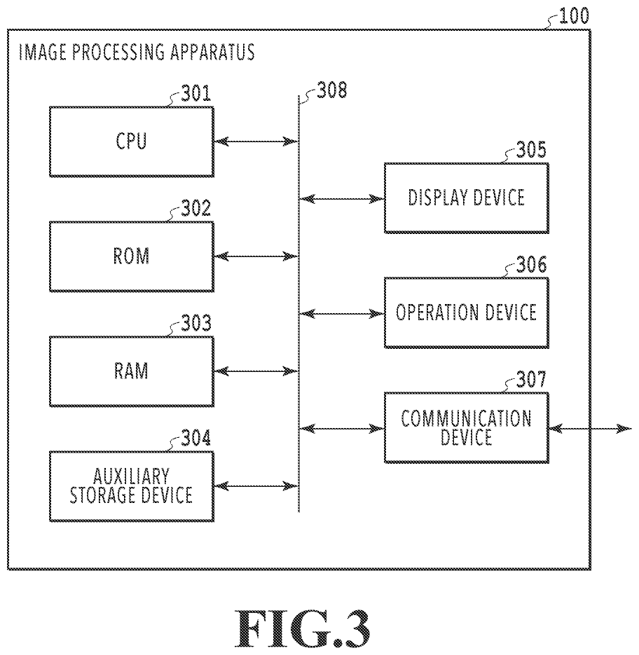

With reference to FIG. 3, the hardware configuration of the image processing apparatus 100 in a case where each unit that the image processing apparatus 100 comprises operates as software is explained. FIG. 3 is a block diagram showing one example of the hardware configuration of the image processing apparatus 100 according to Embodiment 1. The image processing apparatus 100 includes a computer and the computer has, as shown in FIG. 3 as one example, a CPU 301, a ROM 302, a RAM 303, an auxiliary storage device 304, a display device 305, an operation device 306, a communication device 307, and a bus 308.

The CPU 301 is a processor that causes the computer to function as each unit the image processing apparatus 100 comprises as the function configuration by controlling the computer by using programs or data stored in the ROM 302, the RAM 303 or the like. It may also be possible for the image processing apparatus 100 to have one or a plurality of pieces of dedicated hardware different from the CPU 301 and at least part of the processing that is performed by the CPU 301 may be performed by the dedicated hardware. As examples of the dedicated hardware, there are an ASIC, FPGA, DSP (Digital Signal Processor) and the like. The ROM 302 is a memory that stores programs and the like that do not need to be changed. The RAM 303 is a memory that temporarily stores programs or data supplied from the auxiliary storage device 304, or data or the like supplied from the outside via the communication device 307. The auxiliary storage device 304 includes, for example, a hard disk drive and stores programs or various types of data, such as image data and voice data.

The display device 305 includes, for example, a liquid crystal display, an LED or the like and displays a GUI (Graphical User Interface) or the like for a user to operate the image processing apparatus 100 or to browse the state of the processing in the image processing apparatus 100. The operation device 306 includes, for example, a keyboard, a mouse, a joystick, a touch panel or the like and inputs various instructions to the CPU 301 upon receipt of the operation by a user. The CPU 301 operates also as a display control unit configured to control the display device 305 and an operation control unit configured to control the operation device 306.

The communication device 307 is used for communication, such as transmission and reception of data and the like, between the image processing apparatus 100 and an external device. For example, in a case where the image processing apparatus 100 is connected with an external device via a wire, a communication cable is connected to the communication device 307. In a case where the image processing apparatus 100 has a function to wirelessly communicate with an external device, the communication device 307 comprises an antenna. The bus 308 connects each unit the image processing apparatus 100 comprises as hardware configurations and transmits information. In Embodiment 1, explanation is given on the assumption that the display device 305 and the operation device 306 exist inside the image processing apparatus 100, but at least one of the display device 305 and the operation device 306 may exist outside the image processing apparatus 100 as another device.

### <Configuration of Inspection Apparatus 120>

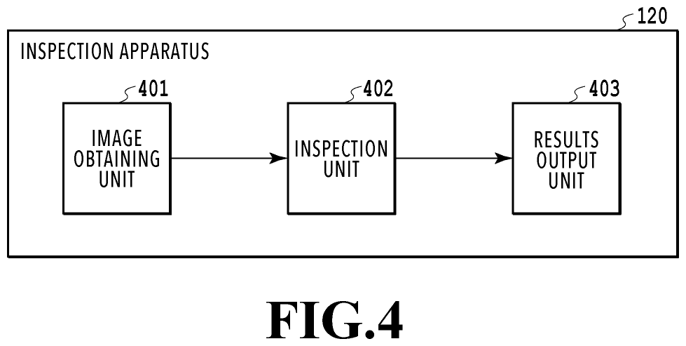

FIG. 4 is a block diagram showing one example of the function configuration of the inspection apparatus 120 according to Embodiment 1. The inspection apparatus 120 comprises an image obtaining unit 401, an inspection unit 402, and a results output unit 403. The processing of each unit the inspection apparatus 120 comprises is performed by hardware, such as ASIC or FPGA, which is incorporated in the inspection apparatus 120. The processing may also be performed by software using a memory, such as a RAM, and a processor, such as a CPU. Specifically, in a case where each unit the inspection apparatus 120 comprises operates as software, for example, the inspection apparatus 120 comprises a hardware configuration similar to the hardware shown in FIG. 3. Details of the processing of each unit the inspection apparatus 120 comprises as the function configuration will be described later.

### <Processing of Image Processing Apparatus>

The processing of each unit the image processing apparatus 100 comprises as the function configuration is explained. The reference image obtaining unit 201 obtains data of an image (in the following, called “reference image”) including a texture pattern (in the following, called “reference texture pattern”) that is taken to be a reference, which is a periodic texture pattern (in the following, simply called “texture pattern”). In the following, data of a reference image is described as reference image data. For example, the reference image obtaining unit 201 obtains reference image data by reading the reference image data stored in advance in the auxiliary storage device 304 or the like. Here, the reference image is, for example, a captured image of a product during manufacture or a manufactured product, and a captured image obtained by capturing the image of a product (in the following, called “reference product”) in which a texture pattern that is taken to be a reference in inspection of the outer appearance of the product is formed.

The target image obtaining unit 202 obtains target image data. Here, the target image is, for example, a captured image obtained by capturing the image of a product during manufacture or a manufactured product (in the following, called “inspection-target product”), which is a captured image of a product to be inspected in inspection of the outer appearance of the product. For example, the target image obtaining unit 202 obtains captured image data as target image data by obtaining the captured image data that is output by the imaging apparatus 110 via the communication line 130, or by reading the captured image data stored in advance in the auxiliary storage device 304 or the like. In the following, explanation is given on the assumption that the captured image data output by the imaging apparatus 110 is stored in the auxiliary storage device 304 or the like and the target image obtaining unit 202 obtains the captured image data as target image data by reading the captured image data stored in the auxiliary storage device 304 or the like.

The reference image data that is obtained by the reference image obtaining unit 201 is data in which the image area corresponding to the reference product in the reference image is arranged in advance at a predetermined position in the reference image. Further, the target image data that is obtained by the target image obtaining unit 202 is data in which the image area corresponding to the inspection-target product in the target image is arranged in advance at a predetermined position. It may also be possible for the target image obtaining unit 202 to perform processing to arrange the image area corresponding to the inspection-target product in the target image at a predetermined position for the obtained target image data.

The area setting unit 203 sets an image area of the reference image, which is used in a case where a two-dimensional spatial frequency component (in the following, called “reference spatial frequency component”) in the reference texture pattern included in the reference image is obtained. Further, the area setting unit 203 sets an image area of the target image, which is used in a case where a two-dimensional spatial frequency component in the texture pattern (in the following, called “target texture pattern”) included in the target image is obtained. In the following, the image area in the reference image, which is set by the area setting unit 203, is called “pattern image area of reference image” and the image area in the target image is called “pattern image area of target image”. Further, the spatial frequency component of the target texture pattern is called “target spatial frequency component”. These pattern image areas are designated by, for example, the input operation by a user using the operation device 306.

The frequency obtaining unit 204 obtains a two-dimensional spatial frequency distribution in an image by using a frequency analysis method, such as fast Fourier transform. Specifically, the frequency obtaining unit 204 obtains information indicating the spatial frequency component (reference spatial frequency component) of the reference texture pattern included in the reference image by obtaining the spatial frequency distribution of the reference image. More specifically, the frequency obtaining unit 204 obtains information indicating the reference spatial frequency component by obtaining the spatial frequency distribution in the pattern image area of the reference image, which is set by the area setting unit 203.

Further, the frequency obtaining unit 204 also obtains information indicating the spatial frequency component (target spatial frequency component) of the target texture pattern included in the target image by obtaining the spatial frequency distribution of the target image. Specifically, the frequency obtaining unit 204 obtains information indicating the target spatial frequency component by obtaining the spatial frequency distribution in the pattern image area of the target image, which is set by the area setting unit 203. Here, the target texture pattern in Embodiment 1 is the same pattern as the reference texture pattern, but the pattern in which a misalignment in its angle has occurred is supposed. Further, the frequency obtaining unit 204 divides the target image into a plurality of micro image areas (in the following, called “micro image areas”) and also obtains the spatial frequency distribution of the target image (in the following, called “micro target image”) corresponding to the micro image area for each divided micro image area.

The matching unit 205 matches the reference spatial frequency component with the target spatial frequency component. Specifically, the mask generation unit 211 generates a spatial frequency mask that masks, in a two-dimensional frequency map, the area of the reference spatial frequency component in a case where the spatial frequency distribution in the pattern image area of the reference image is represented in the two-dimensional frequency map. The angle identification unit 212 identifies the misalignment amount in angle on the frequency map between the reference spatial frequency component and the target spatial frequency component by matching the reference spatial frequency component with the target spatial frequency component on the frequency map. Specifically, the angle identification unit 212 identifies the rotation amount that maximizes the correlation coefficient between the mask area of the spatial frequency mask and the area of the target spatial frequency component in a case where the spatial frequency mask is rotated on the frequency map. Due to this, the angle identification unit 212 identifies the misalignment amount in angle on the frequency map between the reference spatial frequency component and the target spatial frequency component. The corrected mask generation unit 213 generates a corrected spatial frequency mask for masking the target spatial frequency component from the spatial frequency distribution of the target image by using the misalignment amount in angle identified by the angle identification unit 212. Specifically, for example, by rotating the spatial frequency mask by the misalignment amount in angle, the corrected mask generation unit 213 generates a corrected spatial frequency mask corresponding to the rotated spatial frequency mask.

The reduction unit 206 reduces the target spatial frequency component in the spatial frequency distribution of the micro target image for each micro target image by the mask processing using a corrected spatial frequency mask. It is desirable to determine the size of the micro image area based on the size of the mask area in the corrected spatial frequency mask. The image generation unit 207 generates a micro target image after the target texture pattern is reduced from the spatial frequency distribution after the target spatial frequency component is reduced for each micro target image by inverse transform processing, such as inverse fast Fourier transform. Further, the image generation unit 207 generates a target image (reduced target image) after the target texture pattern is reduced by composing the micro target image after the target texture pattern is reduced, which is generated for each micro target image. The image output unit 208 outputs the data of the reduced target image (reduced target image data) to the auxiliary storage device 304, the inspection apparatus 120 or the like.

It may also be possible for the image processing apparatus 100 to generate, in addition to the reduced target image data, an image (in the following, called “reduced reference image) obtained by reducing the reference texture pattern from the reference image and output the data of the reduced reference image for inspection in the inspection apparatus 120, to be described later. In this case, for example, the reduction unit 206 masks the reference spatial frequency component in the spatial frequency distribution of the reference image, which is obtained by the frequency obtaining unit 204, by using the spatial frequency mask generated by the mask generation unit 211. Specifically, the frequency obtaining unit 204 divides the reference image into a plurality of micro image areas (in the following, called “micro image area of reference image”) and obtains the spatial frequency distribution of the corresponding image (in the following, called “micro reference image”) for each divided micro image area of the reference image. It is desirable to determine the size of the micro image area of the reference image based on the size of the mask area in the spatial frequency mask. The reduction unit 206 reduces the reference spatial frequency component in the spatial frequency distribution of each micro reference image by masking the spatial frequency distribution of each micro reference image by using the spatial frequency mask.

Further, in this case, the image generation unit 207 generates the micro reference image after the reference texture pattern is reduced from the spatial frequency distribution after the reference spatial frequency component is reduced for each micro reference image. Further, the image generation unit 207 generates the reference image (reduced reference image) after the reference texture pattern is reduced by composing the micro reference image after the reference texture pattern is reduced, which is generated for each micro reference image. The image output unit 208 outputs the data (in the following, called “reduced reference image data”) of the reduced reference image to the auxiliary storage device 304, the inspection apparatus 120 or the like.

### <Operation of Image Processing Apparatus>

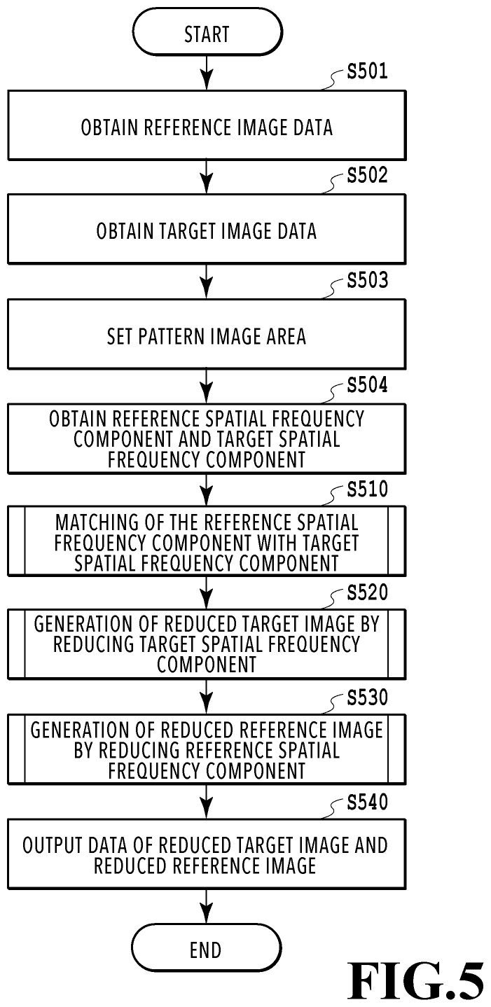

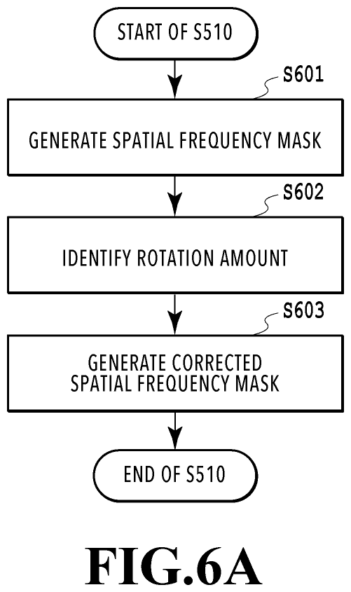

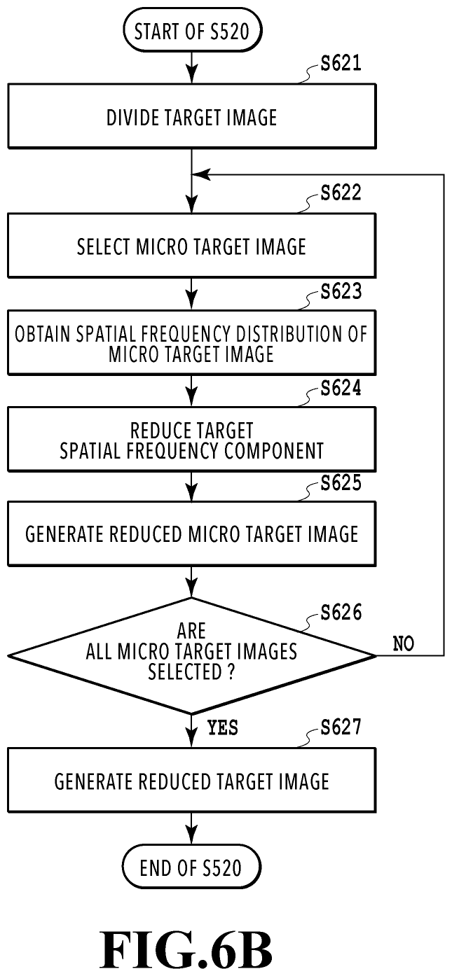

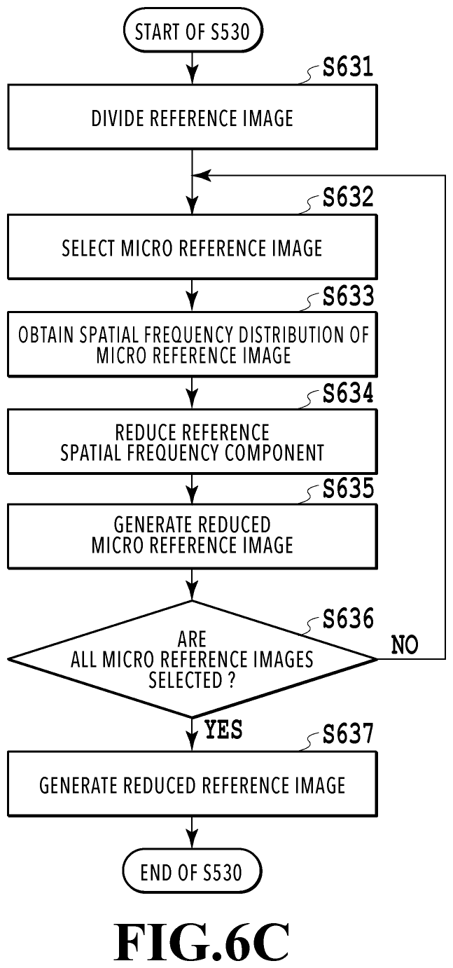

With reference to FIG. 5, FIG. 6A, FIG. 6B, and FIG. 6C, the operation of the image processing apparatus 100 is explained. FIG. 5 is a flowchart showing one example of a processing flow of the image processing apparatus 100 according to Embodiment 1. First, at S501, the reference image obtaining unit 201 obtains reference image data. Next, at S502, the target image obtaining unit 202 obtains target image data. Next, at S503, the area setting unit 203 sets a pattern image area for the reference image obtained at S501 and the target image obtained at S502, respectively. Next, at S504, the frequency obtaining unit 204 obtains the spatial frequency distribution in the pattern image area of the reference image, which is set at S503, and the spatial frequency distribution in the pattern image area of the target image, which is set at S503, and obtains information indicating the reference spatial frequency component and the target spatial frequency component. Next, at S510, the matching unit 205 matches the reference spatial frequency component with the target spatial frequency component.

With reference to FIG. 6A, the processing at S510 shown in FIG. 5 is explained. FIG. 6A is a flowchart showing one example of a processing flow in the matching unit 205 according to Embodiment 1. The flowchart shown in FIG. 6A is performed as the processing at S510 shown in FIG. 5 starts. First, at S601, the mask generation unit 211 generates a spatial frequency mask that masks the area corresponding to the reference spatial frequency component on a frequency map based on the reference spatial frequency component obtained at S504 shown in FIG. 5. Next, at S602, the angle identification unit 212 rotates the spatial frequency mask in order to match the position of the area of the target spatial frequency component with the position of the mask area of the spatial frequency mask on the frequency map and identifies the rotation amount of the spatial frequency mask, which maximizes the correlation coefficient between the areas.

Next, at S603, the corrected mask generation unit 213 generates a corrected spatial frequency mask for masking the area of the target spatial frequency component from the spatial frequency distribution of the target image on the frequency map by using the rotated spatial frequency mask. The data of the corrected spatial frequency mask generated at S603 is stored in the RAM 303, the auxiliary storage device 304 or the like. After S603, the matching unit 205 terminates the processing of the flowchart shown in FIG. 6A.

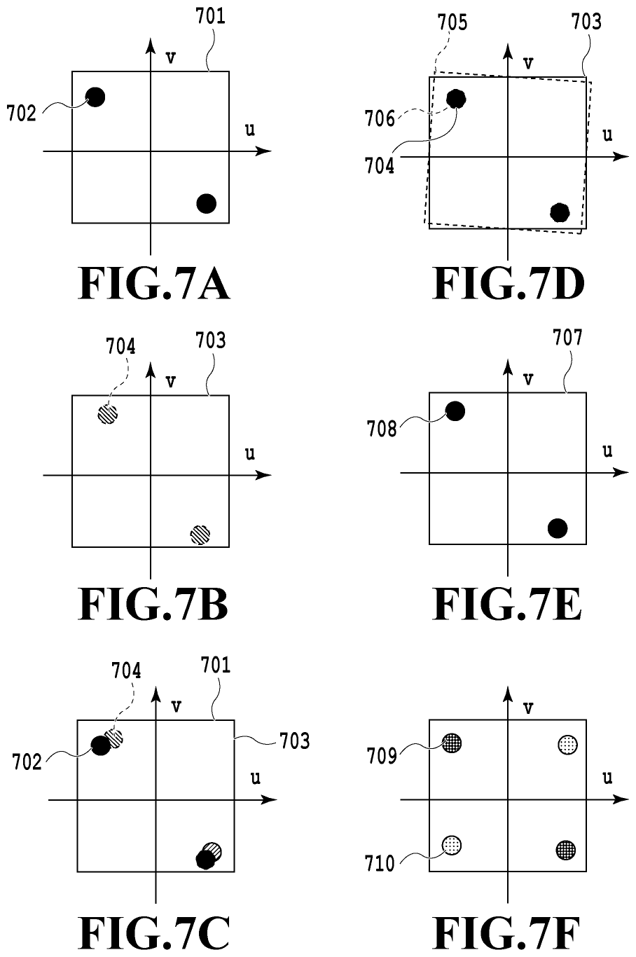

With reference to FIG. 7A to FIG. 7F, the spatial frequency mask and the corrected spatial frequency mask are explained. In FIG. 7A to FIG. 7F, the horizontal axis (u) represents the spatial frequency in the horizontal direction in the reference image and the target image and the vertical axis (v) represents the spatial frequency in the vertical direction in the reference image and the target image. FIG. 7A is a diagram showing one example of a spatial frequency mask 701. Specifically, the spatial frequency mask 701 shown in FIG. 7A includes a mask area 702 that masks the area of the reference spatial frequency component. FIG. 7B is a diagram showing one example of an area 704 of the target spatial frequency component in a spatial frequency distribution 703 of the target image. FIG. 7C is a diagram showing a state where the spatial frequency mask 701 shown in FIG. 7A and the spatial frequency distribution 703 of the target image shown in FIG. 7B are superposed one on another.

FIG. 7D is a diagram showing one example of a state where a rotated spatial frequency mask 705 and the spatial frequency distribution 703 of the target image shown in FIG. 7B are superposed one on another. Specifically, FIG. 7D shows a state where the spatial frequency mask 701 shown in FIG. 7A is rotated and the correlation coefficient between a mask area 706 in the rotated spatial frequency mask 705 and the area 704 of the target spatial frequency component shown in FIG. 7B becomes the maximum. FIG. 7E is a diagram showing one example of a corrected spatial frequency mask 707. The corrected spatial frequency mask 707 shown in FIG. 7E includes a mask area 708 corresponding to the mask area 706 shown in FIG. 7D, which masks the area 704 of the target spatial frequency component.

The mask area 702 shown in FIG. 7A, that is, the reference spatial frequency component represents the spatial frequency distribution corresponding to a stripe-shaped texture pattern in which is linear patterns are arrayed side by side. In a case of a stripe-shaped texture pattern, the spatial frequency component of the texture pattern appears at the point symmetry positions with the origin as the center of symmetry in the spatial frequency map as shown in FIG. 7A.

Further, one example of spatial frequency components 709 and 710 of a texture pattern in a case where the texture pattern is the shape of a mesh in which two types of straight lines whose directions are different from each other intersect each other is shown in FIG. 7F. In this case, as shown in FIG. 7F as one example, the two spatial frequency components 709 and 710 appear at the point symmetry positions with the origin as the center of symmetry in the spatial frequency map. For the texture pattern such as this, for example, it may also be possible to generate two spatial frequency masks corresponding to the spatial frequency components for each spatial frequency component that appears at the point symmetry position in a case where the reference spatial frequency component is matched with the target spatial frequency component. In this case, for example, it may also be possible to rotate the two generated spatial frequency masks independently of each other. Specifically, in this case, for example, it is sufficient to perform the following procedure. First, one of the spatial frequency masks is rotated so that the correlation coefficient between the mask area of the one of the spatial frequency masks and the area of one of the target spatial frequency components becomes the maximum. Following the above, the other spatial frequency mask is rotated so that the correlation coefficient between the mask area of the other spatial frequency mask and the area of the other target spatial frequency component becomes the maximum. Then, a corrected spatial frequency mask is generated by further composing the two rotated spatial frequency masks, which have been rotated independently of each other.

After S510, at S520, the image processing apparatus 100 generates a reduced target image by reducing the target spatial frequency component in the spatial frequency distribution of the target image. The processing at S520 is performed by the frequency obtaining unit 204, the reduction unit 206, and the image generation unit 207. With reference to FIG. 6B, the processing at S520 is explained. FIG. 6B is a flowchart showing one example of a processing flow in the processing at S520 shown in FIG. 5. The flowchart shown in FIG. 6B is performed as the processing at S520 shown in FIG. 5 starts.

First, at S621, the frequency obtaining unit 204 divides the target image into a plurality of micro target images. Here, the size of the micro image area is determined based on, for example, the size of the mask area in the corrected spatial frequency mask generated at S603. Next, at S622, the frequency obtaining unit 204 selects an arbitrary micro target image from among the plurality of divided micro target images. Next, at S623, the frequency obtaining unit 204 obtains the spatial frequency distribution of the micro target image selected at S622. Next, at S624, the reduction unit 206 reduces the target spatial frequency component in the spatial frequency distribution of the micro target image by the mask processing using the corrected spatial frequency mask generated at S603. Next, at S625, the image generation unit 207 generates an image (reduced micro target image) obtained by reducing the target texture pattern from the micro target image by using the spatial frequency distribution after the target spatial frequency component is reduced in the micro target image.

Next, at S626, the frequency obtaining unit 204 determines whether or not all the micro target images are selected at S622. In a case where it is determined that one or some of the micro target images are not selected at S626, the image processing apparatus 100 returns to the processing at S622 and repeatedly performs the processing at S622 to S626 until it is determined that all the micro target images are selected at S626. In this case, the image processing apparatus 100 selects the micro target image that is not selected yet at S622 and performs the processing at S623 to S626. In a case where it is determined that all the micro target images are selected at S626, the image generation unit 207 generates, at S627, a reduced target image by composing the plurality of reduced micro target images generated at S625. After S627, the image processing apparatus 100 terminates the processing of the flowchart shown in FIG. 6B.

After S520, at S530, the image processing apparatus 100 generates a reduced reference image by reducing the reference spatial frequency component in the spatial frequency distribution of the reference image. The processing at S530 is performed by the frequency obtaining unit 204, the reduction unit 206, and the image generation unit 207. With reference to FIG. 6C, the processing at S530 is explained. FIG. 6C is a flowchart shoring one example of a processing flow in the processing at S530 shown in FIG. 5. The flowchart shown in FIG. 6C is performed as the processing at S530 shown in FIG. 5 starts.

First, at S631, the frequency obtaining unit 204 determines the size of the image area in a case where the reference image is divided based on the size of the mask area in the spatial frequency mask generated at S601 and divides the reference image into a plurality of micro reference images. Next, at S632, the frequency obtaining unit 204 selects an arbitrary micro reference image from among the plurality of micro reference images. Next, at S633, the frequency obtaining unit 204 obtains the spatial frequency distribution of the micro reference image selected at S632. Next, at S634, the reduction unit 206 reduces the reference spatial frequency component in the spatial frequency distribution of the micro reference image by the mask processing using the spatial frequency mask generated at S601. Next, at S635, the image generation unit 207 generates an image (reduced micro reference image) obtained by reducing the target texture pattern in the micro reference image by using the spatial frequency distribution after the reference spatial frequency component is reduced in the micro reference image.

Next, at S636, the frequency obtaining unit 204 determines whether or not all the micro reference images are selected at S632. In a case where it is determined that one or some of the micro reference images are not selected at S636, the image processing apparatus 100 returns to the processing at S632 and repeatedly performs the processing at S632 to S636 until it is determined that all the micro reference images are selected at S636. In this case, the image processing apparatus 100 selects the micro reference image that is not selected yet at S632 and performs the processing at S633 to S636. In a case where it is determined that all the micro reference images are selected at S636, the image generation unit 207 generates, at S637, a reduced reference image by composing the plurality of reduced micro reference images generated at S635. After S637, the image processing apparatus 100 terminates the processing of the flowchart shown in FIG. 6C. After S530, at S540, the image output unit 208 outputs the data of the reduced target image generated at S520 and the data of the reduced reference image generated at S530. After S540, the image processing apparatus 100 terminates the processing of the flowchart shown in FIG. 5.

According to the image processing apparatus 100 configured as above, even in a case where there are variations in the direction of a texture pattern, it is possible to easily reduce the texture pattern from an image without the need to perform complicated work. In a case where the reduced target image is generated continuously for a plurality of pieces of target image data corresponding to a plurality of inspection-target products, it is recommended to store the data of the spatial frequency mask generated at S601 in the auxiliary storage device 304 or the like. Due to this, it is no longer necessary to perform the series of processing for generating the spatial frequency mask for each piece of target image data. Further, in this case, it is also recommended to store the data of the reduced reference image generated at S530 in the auxiliary storage device 304 or the like. Due to this, it is no longer necessary to perform the series of processing for generating the reduced reference image for each piece of target image data.

### <GUI of Image Processing Apparatus>

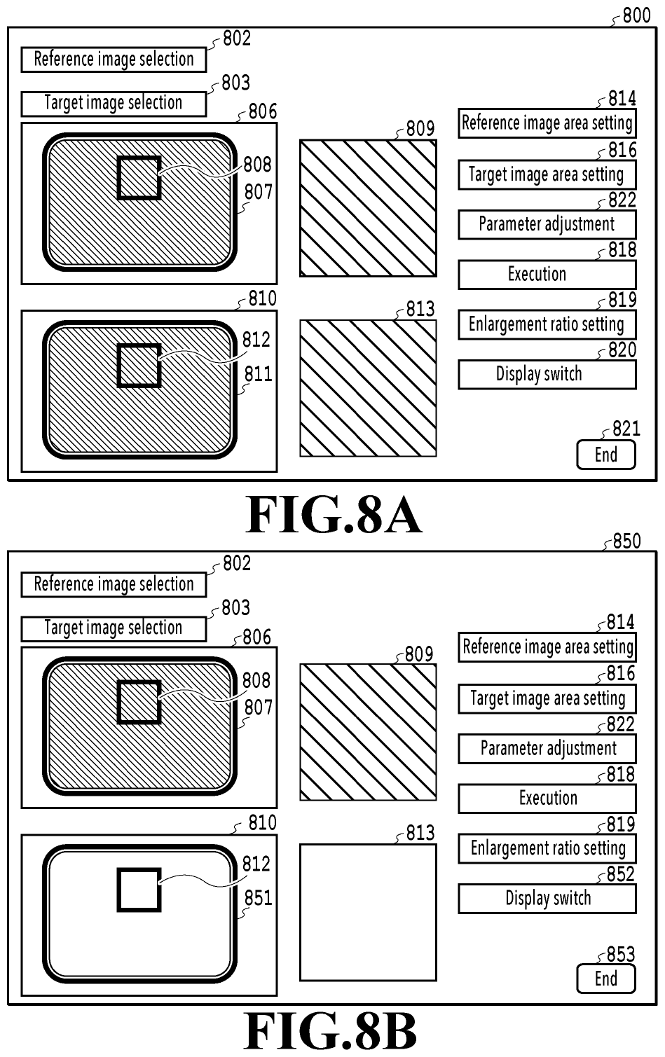

With reference to FIG. 8A and FIG. 8B, GUIs 800 and 850 that the image processing apparatus 100 causes the display device 305 to display are explained. FIG. 8A is a diagram showing one example of the GUI 800 of the image processing apparatus 100 according to Embodiment 1. Specifically, the GUI 800 shown in FIG. 8A is a display screen for performing the setting operation before performing reduction processing of a texture pattern in a target image and the start operation of the execution of the reduction processing. FIG. 8B is a diagram showing one example of the GUI 850 of the image processing apparatus 100 according to Embodiment 1. Specifically, the GUI 850 shown in FIG. 8B is a display screen for displaying results of reduction processing of a texture pattern in a target image.

The GUI 800 includes a Reference image selection button 802 and a Target image selection button 803. The Reference image selection button 802 is a button for causing a user to select reference image data that is obtained by the reference image obtaining unit 201. In a case when the Reference image selection button 802 is pressed down by the input operation by a user, the image processing apparatus 100 causes the display device 305 to display a file selection screen, not shown schematically in FIG. 8A or FIG. 8B. A user selects a file corresponding to desired reference image data on the file selection screen. The reference image obtaining unit 201 obtains the reference image data by reading the file selected on the file selection screen from the auxiliary storage device 304 or the like. A reference image 807 indicated by the obtained reference image data is displayed in a display area 806.

The Target image selection button 803 is a button for causing a user to select target image data that is obtained by the target image obtaining unit 202. In a case where the Target image selection button 803 is pressed down by the input operation by a user, the image processing apparatus 100 causes the display device 305 to display a file selection screen, not shown schematically in FIG. 8A or FIG. 8B. A user selects a file corresponding to desired target image data on the file selection screen. The target image obtaining unit 202 obtains the target image data by reading the file selected on the file selection screen from the auxiliary storage device 304 or the like. A target image 811 indicated by the obtained target image data is displayed in a display area 810.

The GUI 800 includes a Reference image area setting button 814 and a Target image area setting button 816. The Reference image area setting button 814 is a button for causing a user to input information indicating the pattern image area of the reference image, which is set by the area setting unit 203. In a case where the Reference image area setting button 814 is pressed down by the input operation by a user, the image processing apparatus 100 causes the display device 305 to display an area designation screen, not shown schematically in FIG. 8A or FIG. 8B. A user inputs information capable of identifying a desired image area in the reference image on the area designation screen. The information capable of identifying the image area is, for example, in a case where the image area is a rectangle, information indicating the position of the top left and the position of the bottom right of the image area, information indicating the position of the top left of the image area and the width and the height of the image area, or the like.

In the setting of the pattern image area of the reference image, it is desirable for the information capable of identifying the image area to be input so that the image area whose texture pattern is displayed vividly in the reference image 807 displayed in the display area 806 is set as the pattern image area of the reference image. The area setting unit 203 designates the pattern image area of the reference image based on the information capable of identifying the image area, which is input on the area designation screen. A rectangular frame 808 indicating the pattern image area of the reference image, which is designated by the area setting unit 203, is displayed in an overlapping manner in the reference image 807 displayed in the display area 806. The method of inputting the information capable of identifying the image area in the reference image by a user is not limited to the above-described method. For example, it may also be possible for a user to input the information capable of identifying the image area in the reference image by selecting the side or the corner of the rectangular frame 808 and changing the position thereof.

The Target image area setting button 816 is a button for causing a user to input the information indicating the pattern image area of the target image, which is set by the area setting unit 203. In a case where the Target image area setting button 816 is pressed down by the input operation by a user, the image processing apparatus 100 causes the display device 305 to display an area designation screen not shown schematically in FIG. 8A or FIG. 8B. A user inputs the information capable of identifying a desired image area in the target image on the area designation screen. In the setting of the pattern image area of the target image, it is desirable to input the information capable of identifying the image area so that the image area whose texture pattern is displayed vividly in the target image 811 displayed in the display area 810 is set as the pattern image area of the target image. The area setting unit 203 designates the pattern image area of the target image based on the information capable of identifying the image area, which is input on the area designation screen. A rectangular frame 812 indicating the pattern image area of the target image, which is designated by the area setting unit 203, is displayed in an overlapping manner in the target image 811 displayed in the display area 810.

The method of inputting the information capable of identifying the image area in the target image by a user is not limited to the above-described method. For example, it may also be possible for a user to input the information capable of identifying the image area in the target image by selecting the side or the corner of the rectangular frame 812 and changing the position thereof. Further, it may also be possible for the image processing apparatus 100 not to receive the input of the information capable of identifying the image area in the target image. In this case, for example, the area setting unit 203 sets the image area of the target image, which corresponds to the position and the size of the pattern image area of the reference image, as the pattern image area of the target image. In a display area 809, the image obtained by enlarging the reference image within the image area corresponding to the rectangular frame 808 is displayed and in a display area 813, the image obtained by enlarging the target image within the image area corresponding to the rectangular frame 812 is displayed.

The GUI 800 includes an Enlargement ratio setting button 819. The Enlargement ratio setting button 819 is a button for setting the display enlargement ratio of the image that is displayed in the display area 809 and the display area 813. In a case where the enlargement ratio setting button 819 is pressed down by the input operation by a user, the image processing apparatus 100 causes the display device 305 to display an enlargement ratio setting screen not shown schematically in FIG. 8A or FIG. 8B. A user inputs information indicating the enlargement ratio on the enlargement ratio setting screen. The method of setting an enlargement ratio is not limited to the above-described method. For example, a method of selecting a desired enlargement ratio from a plurality of predetermined enlargement ratios by using a pulldown menu or the like may also be accepted, or a method of designating a desired enlargement ratio by using a slide bar or the like may also be accepted.

The GUI 800 includes a Parameter adjustment button 822. The Parameter adjustment button 822 is a button for displaying a parameter adjustment screen that is used in a case where the parameter to rotate a spatial frequency mask is adjusted manually. In a case where the Parameter adjustment button 822 is pressed down by the input operation by a user, the image processing apparatus 100 causes the display device 305 to display a parameter adjustment screen, to be described later. The GUI 800 includes an Execution button 818. In a case where the Execution button 818 is pressed down by the input operation by a user, the image processing apparatus 100 performs processing to reduce the texture pattern in the target image.

In a case where the processing to reduce the texture pattern in the target image is completed, the image processing apparatus 100 causes the display device 305 to display the GUI 850 shown in FIG. 8B as one example in place of the GUI 800. In the display area 810 on the GUI 850, a target image (reduced target image) 851 after the texture pattern is reduced is displayed. Further, in the display area 813 on the GUI 850, the image obtained by enlarging the reduced target image within the image area, which corresponds to the rectangular frame 812, is displayed. It is possible for a user to check how degree the target texture pattern is reduced in the reduced target image by checking the reduced target image displayed in the display area 810 or the display area 813.

The GUI 850 includes a Display switch button 852 and an End button 853. In a case where the Display switch button 852 is pressed down by the input operation by a user, the image processing apparatus 100 causes the display device 305 to display the GUI 800 in place of the GUI 850. In a case where the End button 853 is pressed down by the input operation by a user, the image processing apparatus 100 terminates the display of the GUI 850 and the GUI 800. Further, the GUI 800 includes a Display switch button 820 and an End button 821. In a case where the Display switch button 820 is pressed down by the input operation by a user, the image processing apparatus 100 causes the display device 305 to display the GUI 850 in place of the GUI 800. In a case where the End button 821 is pressed down by the input operation by a user, the image processing apparatus 100 terminates the display of the GUI 800 and the GUI 850.

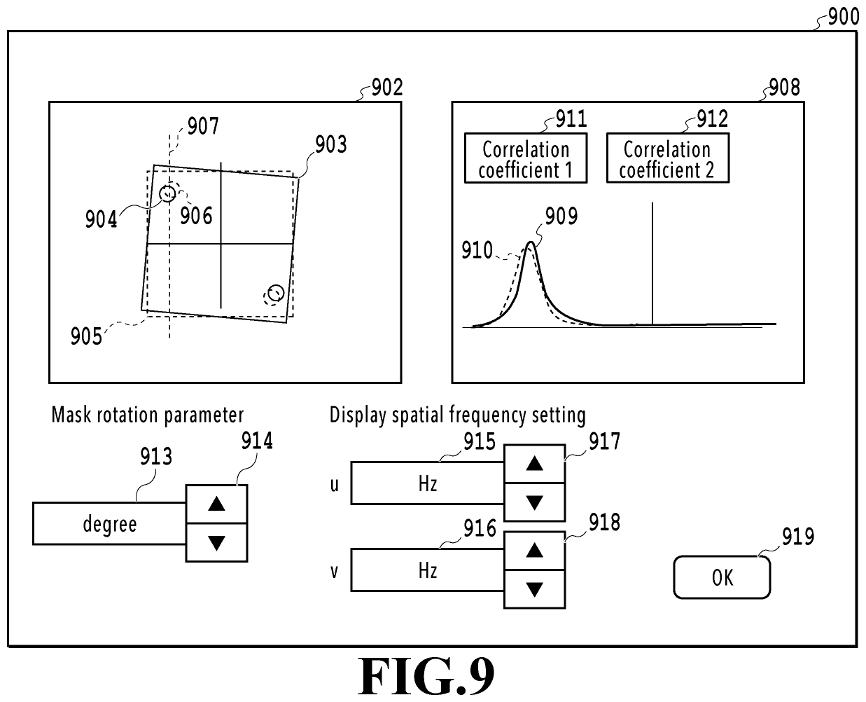

With reference to FIG. 9, the above-described parameter adjustment screen is explained. FIG. 9 is a diagram showing one example of a GUI 900 for parameter adjustment according to Embodiment 1. It is possible for a user to manually adjust parameters in a case where a spatial frequency mask is rotated in texture pattern reduction processing by using the GUI 900. The GUI 900 includes a display area 902 and a display area 908. In the display area 902, a spatial frequency mask 903 and an area 906 of the spatial frequency component (target spatial frequency component) of the target texture pattern are displayed. The spatial frequency mask 903 has a mask area 904 corresponding to the area of the spatial frequency component (reference spatial frequency component) of the reference texture pattern. In the display area 908, an intensity distribution 909 of the spatial frequency mask 903 and an intensity distribution 910 of a target spatial frequency component 905, at a display frequency 907 of an arbitrary u value or a v value in the spatial frequency map are displayed.

The GUI 900 includes frequency setting areas 915 and 916. The frequency setting areas 915 and 916 are each a display area for setting the display frequency 907 of the arbitrary u value or the v value in the spatial frequency map in a case where the intensity distribution is displayed in the display area 908. It is possible for a user to input a desired value of the display frequency 907 by performing the input operation for the frequency setting areas 915 and 916. The GUI 900 may include frequency change buttons 917 and 918. In this case, it is possible for a user to change the value of the display frequency 907 by pressing down the frequency change button 917 or 918. The GUI 900 includes a display area 911 and a display area 912. In the display area 911, a correlation coefficient between the spatial frequency mask 903 and the target spatial frequency component 905 at the display frequency of the arbitrary u value or the v value set by a user is displayed. Further, in the display area 912, a correlation coefficient between the spatial frequency mask 903 and the target spatial frequency component 905, in the spatial frequency map is displayed.

The GUI 900 includes a rotation amount setting area 913. It is possible for a user to input the value of a desired rotation amount in a case where the spatial frequency mask 903 is rotated by performing the input operation for the rotation amount setting area 913. The GUI 900 may include a rotation amount change button 914. In this case, it is possible for a user to change the rotation amount of the spatial frequency mask 903 by pressing down the rotation amount change button 914. The GUI 900 includes an OK button 919. In a case where the OK button 919 is pressed down by the input operation by a user, the image processing apparatus 100 causes the auxiliary storage device 304 or the like to store information indicating the set rotation amount of the spatial frequency mask and terminates the display on the GUI 900. According to GUI 900, it is possible for a user to adjust and set the rotation amount of the spatial frequency mask to an arbitrary value while referring to the correlation coefficient that is displayed in the display area 511 or the display area 512.

### <Processing of Inspection Apparatus>

The processing of each unit the inspection apparatus 120 comprises as the function configuration is explained. The image obtaining unit 401 obtains reduced target image data. Specifically, the image obtaining unit 401 obtains the reduced target image data that the image processing apparatus 100 outputs from the image processing apparatus 100 via the communication line 140. It may also be possible for the image obtaining unit 401 to obtain the reduced target image data by reading it from a storage device or the like comprised inside or outside the inspection apparatus 120. The inspection unit 402 performs inspection to identify whether or not there is a defect on the outer appearance on the surface or the like of an inspection-target product on the surface or the like of which a texture pattern is formed by using the reduced target image data. The inspection by the inspection unit 402 may be inspection to identify the type, the position or the like of a defect in a case where the defect exists, as well as identifying the presence/absence of a defect on the outer appearance of the inspection-target product.

Specifically, the inspection unit 402 performs the above-described inspection by comparing the reduced target image data and the reduced reference image data. In this case, for example, the image obtaining unit 401 obtains the reduced reference image data that the image processing apparatus 100 outputs from the image processing apparatus 100 via the communication line 140. It may also be possible for the image obtaining unit 401 to obtain the reduced reference image data by reading it from a storage device or the like comprised inside or outside the inspection apparatus 120. The inspection method of the inspection unit 402 is not limited to the method of comparing the reduced target image data and the reduced reference image data as long as it is possible to identify whether or not there is a defect on the outer appearance on the surface or the like of an inspection-target product by using the reduced target image data.

The results output unit 403 outputs information (in the following, called “inspection results information”) indicating inspection results by the inspection unit 402. For example, the results output unit 403 causes a display device, not shown schematically, connected to the inspection unit 402 to display inspection results information by converting the inspection results information into a display image and outputting a signal indicating the display image to the display device. Specifically, for example, it may also be possible for the results output unit 403 to cause the above-described display device to display information indicating the type, the position or the like of a defect identified by the inspection unit 402, in addition to information indicating the presence/absence of a defect as the inspection results information. The output destination of the inspection results information by the results output unit 403 is not limited to the display device and it may also be possible for the results output unit 403 to output the inspection results information to a storage device comprised inside or outside the inspection apparatus 120 and cause the storage device to store the inspection results information.

### <Operation of Inspection Apparatus>

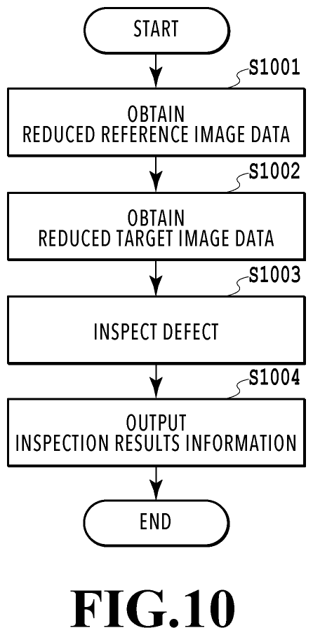

With reference to FIG. 10, the operation of the inspection apparatus 120 is explained. FIG. 10 is a flowchart showing one example of a processing flow of the inspection apparatus 120 according to Embodiment 1. First, at S1001, the image obtaining unit 401 obtains reduced reference image data. Next, at S1002, the image obtaining unit 401 obtains reduced target image data. It may also be possible for the image obtaining unit 401 to obtain target image data, in addition to the reduced target image data at S1002. In the following, explanation is given on the assumption that the image obtaining unit 401 also obtains target image data. Next, at S1003, the inspection unit 402 performs inspection of a defect on the outer appearance of the surface or the like of an inspection-target product by using the reduced target image data. Next, at S1004, the results output unit 403 outputs inspection results information. After S1004, the inspection apparatus 120 terminates the processing of the flowchart shown in FIG. 10. In a case of continuously inspecting a plurality of inspection-target products, it may be possible for the inspection apparatus 120 to repeatedly perform the processing at S1002 to S1004 for each inspection-target product by using the reduced reference image data obtained at S1001. Due to this, it is possible to omit the processing to obtain the reduced reference image data for each inspection-target product.

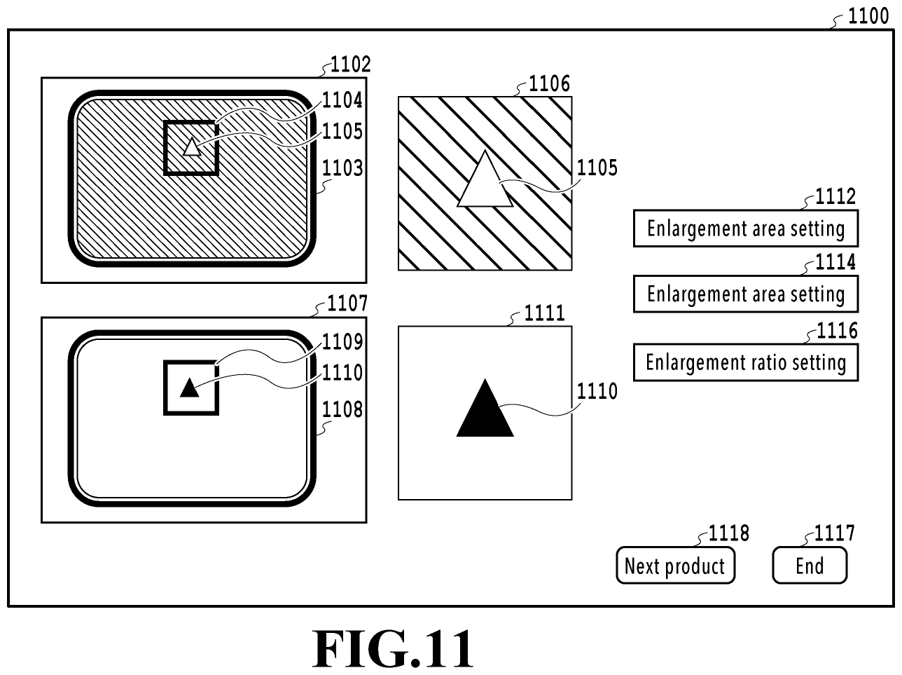

In the following, explanation is given on the assumption that the results output unit 403 causes a display device to display inspection results information by converting the inspection results information into a display image and outputting a signal indicating the display image to the display device. With reference to FIG. 11, the inspection results information that the inspection apparatus 120 causes the display device to display as the display image is explained. FIG. 11 is a diagram showing one example of a display image 1100 that the inspection apparatus 120 causes the display device to display.

The display image 1100 includes display areas 1102 and 1106 and an Enlargement area setting button 1112. In the display area 1102, a target image is displayed. The results output unit 403 arranges a target image 1103 represented by target image data obtained by the image obtaining unit 401 in the display area 1102. The Enlargement area setting button 1112 is a button for setting an image area of the target image, which a user desires to display in an enlarged size. In a case where the Enlargement area setting button 1112 is pressed down by the input operation by a user, the inspection apparatus 120 causes the display device to display an area designation screen, not shown schematically in FIG. 11. A user inputs information capable of identifying the image area in the target image, which the user desires to display in an enlarged size, on the area designation screen. The information capable of identifying the image area is, in a case where the image area is a rectangle, for example, information indicating the top-left position and the bottom-right position of the image area, information indicating the top-left position of the image area and the width and height of the image area, or the like. A rectangular frame 1104 shown in the display area 1102 indicates the image area in a case where the target image is displayed in an enlarged size. In the display area 1106, the image area of the target image, which corresponds to the rectangular frame 1104, is displayed in an enlarged size. The results output unit 403 arranges the image obtained by enlarging the image area of the target image, which corresponds to the rectangular frame 1104, in the display area 1106.

The display image 1100 includes display areas 1107 and 1111 and an Enlargement area setting button 1114. In the display area 1107, a reduced target image is displayed. The results output unit 403 arranges a reduced target image 1108 represented by the reduced target image data obtained by the image obtaining unit 401 in the display area 1107. The Enlargement area setting button 1114 is a button for setting the image area of the reduced target image, which a user desires to display in an enlarged size. In a case where the Enlargement area setting button 1114 is pressed down by the input operation by a user, the inspection apparatus 120 causes the display device to display an area designation screen, not shown schematically in FIG. 11. A user inputs information capable of identifying the image area in the reduced target image, which the user desires to display in an enlarged size, on the area designation screen. A rectangular frame 1109 shown in the display area 1107 indicates the image area in a case where the reduced target image is displayed in an enlarged size. In the display area 1111, the image area of the reduced target image, which corresponds to the rectangular frame 1109, is displayed in an enlarged size. The results output unit 403 arranges the image obtained by enlarging the image area of the reduced target image, which corresponds to the rectangular frame 1109, in the display area 1111.

The display image 1100 includes an Enlargement ratio setting button 1116. The Enlargement ratio setting button 1116 is a button for setting a display enlargement ratio of an image that is displayed in the display areas 1106 and 1111. In a case where the Enlargement ratio setting button 1116 is pressed down by the input operation by a user, the inspection apparatus 120 causes the display device to display an enlargement ratio setting screen, not show schematically in FIG. 11. A user inputs information indicating an enlargement ratio on the enlargement ratio setting screen. The method of setting an enlargement ratio is not limited to that described above. For example, a method of selecting a desired enlargement ratio from a plurality of predetermined enlargement ratios by using a pulldown menu or the like may also be accepted, or a method of designating a desired enlargement ratio by using a slide bar or the like may also be accepted.

The display image 1100 includes a Next product button 1118 and an End button 1117. In a case where the Next product button 1118 is pressed down by the input operation by a user, the inspection apparatus 120 performs the processing at S1002 to S1004 shown in FIG. 10 for the next inspection-target product and causes the display device to display the display image 1100 of the inspection-target product. In a case where the End button 1117 is pressed down by the input operation by a user, the inspection apparatus 120 terminates the display of the display image 1100.

In FIG. 11, a triangle 1105 shown in the display areas 1102 and 1106 and a triangle 1110 shown in the display areas 1107 and 1111 each indicates one example of a defective portion in the inspection-target product. The triangles 1105 and 1110 each indicate an area whose color, shape or the like is different from that in the reduced reference image as a defective portion by a comparison with the reduced reference image. For example, it may also be possible to indicate a defective portion by using a color, brightness or the like in accordance with the degree of the difference from the reduced reference image. By checking the display image 1100 for the detective portion such as this, it is possible for a user to recognize the presence/absence of a defect on the outer appearance on the surface or the like of the inspection-target product. In the display image 1100 shown in FIG. 11, the target image and the reduced target image are displayed one on another, but it may also be possible to enable switching between the display of the target image and the display of the reduced target image by preparing a display switch button or the like.

According to the inspection system 1 configured as above, even in a case where there are variations in the direction of the texture pattern, it is possible to easily reduce the texture pattern in an image and perform inspection of an inspection-target product without the need to perform complicated work. In the present embodiment, explanation is given on the assumption that the inspection system 1 comprises the inspection apparatus 120 separately from the image processing apparatus 100, but the configuration of the inspection system 1 is not limited to this. For example, it may also be possible for the image processing apparatus 100 to comprise each unit that the inspection apparatus 120 comprises as the function configuration and perform the above-described inspection in place of the inspection apparatus 120. Further, in the present embodiment, the aspect is explained in which the texture pattern in the target image is reduced, which is formed intentionally, but it is also possible to apply the image processing apparatus 100 to the reduction of the texture pattern included in an image as noise.

### Embodiment 2

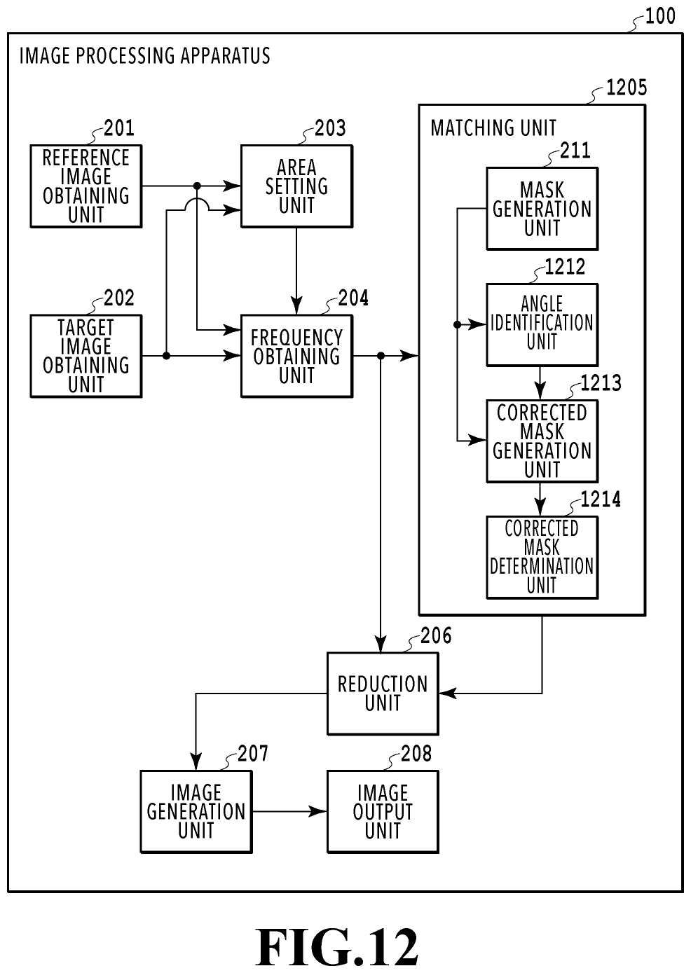

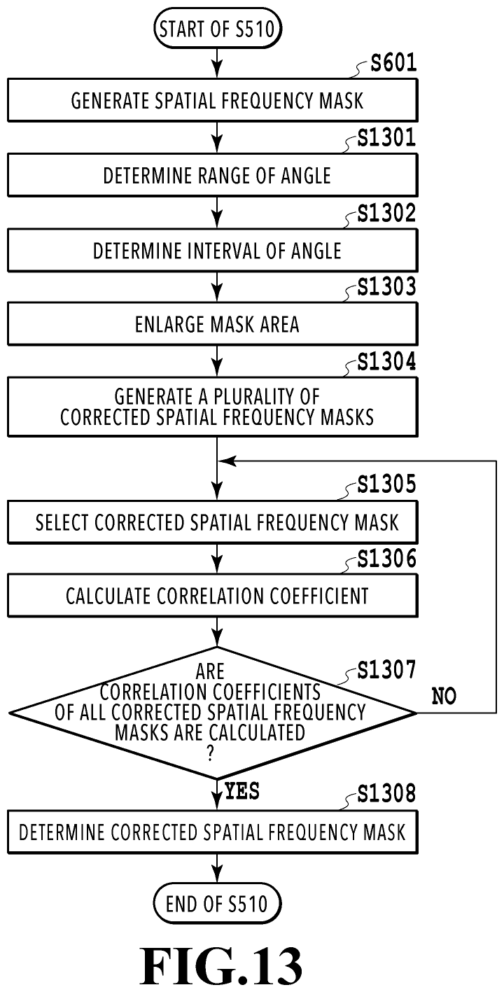

With reference to FIG. 12 and FIG. 13, the image processing apparatus 100 according to Embodiment 2 is explained. The image processing apparatus 100 according to Embodiment 1 identifies each time the rotation amount of the spatial frequency mask, which maximizes the correlation coefficient with the target spatial frequency component, in a case where the area of the target spatial frequency component is matched with the mask area of the spatial frequency mask on the frequency map. In contrast to this, the image processing apparatus 100 according to Embodiment 2 prepares in advance a plurality of corrected spatial frequency masks and determines a corrected spatial frequency mask from among them, which is used in a case where the target spatial frequency component is reduced.

FIG. 12 is a block diagram showing one example of the function configuration of the image processing apparatus 100 (in the following, simply described as “image processing apparatus 100”) according to Embodiment 2. In FIG. 12, to the same configuration as the function configuration shown in FIG. 2, the same symbol is attached and explanation is omitted. The image processing apparatus 100 comprises the reference image obtaining unit 201, the target image obtaining unit 202, the area setting unit 203, the frequency obtaining unit 204, a matching unit 1205, the reduction unit 206, the image generation unit 207, and the image output unit 208. Further, the matching unit 1205 comprises the mask generation unit 211, an angle identification unit 1212, a corrected mask generation unit 1213, and a corrected mask determination unit 1214. The processing of each unit the image processing apparatus 100 comprises as the function configuration is performed by hardware, such as an ASCI or an FPGA, which is incorporated in the image processing apparatus 100. Further, the processing may be performed by software using a memory, such as a RAM, and a processor, such as a CPU. In the following, explanation is given on the assumption that the image processing apparatus 100 includes the computer shown in FIG. 3 as one example and each unit the image processing apparatus 100 comprises as the function configuration operates as software.

The matching unit 1205 matches the reference spatial frequency component with the target spatial frequency component and determines a corrected spatial frequency mask that is used to reduce the target spatial frequency component from among a plurality of corrected spatial frequency masks generated in advance. Specifically, the mask generation unit 211 generates a spatial frequency mask. The angle identification unit 1212 determines the range of angle in which the spatial frequency mask is rotated and the interval of the angle by which the spatial frequency mask is rotated in accordance with the distribution characteristic of the area of the reference spatial frequency component on the frequency map. The corrected mask generation unit 1213 generates a plurality of corrected spatial frequency masks by rotating the spatial frequency mask at each interval of the angle determined by the angle identification unit 1212 and generating a corrected spatial frequency mask corresponding to the rotated spatial frequency mask. The corrected mask generation unit 1213 causes the auxiliary storage device 304 or the like to store the data of each generated corrected spatial frequency mask.

The corrected mask determination unit 1214 determines a corrected spatial frequency mask that is used in a case where the reduction unit 206 reduces the target spatial frequency component in the spatial frequency distribution of the target image. Specifically, the corrected mask determination unit 1214 identifies the corrected spatial frequency mask that maximizes the correlation coefficient between the area of the target spatial frequency component and the mask area of the corrected spatial frequency mask on the frequency map from the plurality of corrected spatial frequency masks. The corrected mask determination unit 1214 determines the identified corrected spatial frequency mask that maximizes the correlation coefficient as the corrected spatial frequency mask that the reduction unit 206 uses in a case where the target spatial frequency component is reduced in the spatial frequency distribution of the target image. The reduction unit 206 reduces the target spatial frequency component in the spatial frequency distribution of the target image by the mask processing using the corrected spatial frequency mask determined by the corrected mask determination unit 1214. Specifically, for example, the reduction unit 206 reduces the target spatial frequency component in the spatial frequency distribution of the micro target image by the mask processing for each micro target image.

The operation of the image processing apparatus 100 is explained. The processing flow of the image processing apparatus 100 is the same as the flowchart shown in FIG. 5 except in that the processing at S510 in the flowchart shown in FIG. 5 is performed by the matching unit 1205. With reference to FIG. 13, the processing at S510 by the matching unit 1205 is explained. FIG. 13 is a flowchart showing one example the processing flow of the matching unit 1205 the image processing apparatus 100 according to Embodiment 2 comprises. The flowchart shown in FIG. 13 is performed as the processing at S510 in the flowchart shown in FIG. 5 starts. In FIG. 13, to the same processing as the processing shown in FIG. 6A, the same symbol is attached and explanation is omitted.

First, at S601, the mask generation unit 211 generates a spatial frequency mask. Next, at S1301, the angle identification unit 1212 determines the range of angle in which the spatial frequency mask is rotated in accordance with the distribution characteristic of the area of the reference spatial frequency component on the frequency map, that is, the mask area of the spatial frequency mask generated at S601. Next, at S1302, the angle identification unit 1212 determines the interval of the angle by which the spatial frequency mask is rotated in accordance with the distribution characteristic of the area of the reference spatial frequency component on the frequency map, that is, the mask area of the spatial frequency mask generated at S601. Next, at S1303, the corrected mask generation unit 1213 enlarges the mask area of the spatial frequency mask generated at S601 in an appropriate range. Here, it is desirable for the size of the range in which the mask area is enlarged to be determined based on the interval of the angle determined at S1302.

Next, at S1304, the corrected mask generation unit 1213 generates a plurality of corrected spatial frequency masks. Specifically, at S1304, the corrected mask generation unit 1213 rotates the spatial frequency mask whose mask area has been enlarged at S1303 at the interval of the angle determined at S1302 a plurality of times in the range of angle determined at S1301. Further, at S1304, the corrected mask generation unit 1213 generates a corrected spatial frequency mask corresponding to the rotated spatial frequency mask whose mask area has been enlarged at each rotation. The corrected mask generation unit 1213 causes the auxiliary storage device 304 or the like to store the data of each corrected spatial frequency mask generated at S1304. Next, at S1305, the corrected mask determination unit 1214 selects an arbitrary corrected spatial frequency mask from among the plurality of corrected spatial frequency masks generated at S1304. Next, at S1306, the corrected mask determination unit 1214 calculates a correlation coefficient between the area of the target spatial frequency component and the mask area of the corrected spatial frequency mask selected at S1305.

Next, at S1307, the corrected mask determination unit 1214 determines whether or not the correlation coefficient is calculated for all the corrected spatial frequency masks. In a case where it is determined that the correlation coefficient is not calculated for one or some of the corrected spatial frequency masks at S1307, the corrected mask determination unit 1214 returns to S1305 and performs the processing at S1305 to S1307 again. At this time, at S1305, the corrected mask determination unit 1214 selects an arbitrary corrected spatial frequency mask from among one or more corrected spatial frequency masks not selected yet. In a case where it is determined that the correlation coefficient is calculated for all the corrected spatial frequency masks at S1307, the corrected mask determination unit 1214 performs the processing at S1308. At S1308, the corrected mask determination unit 1214 determines the corrected spatial frequency mask that maximizes the correlation coefficient as the corrected spatial frequency mask that is used in a case where the reduction unit 206 reduces the target spatial frequency component in the spatial frequency distribution of the micro target image. After S1308, the matching unit 1205 terminates the processing of the flowchart shown in FIG. 13.

As one example, the aspect is explained in which the image processing apparatus 100 generates the corrected spatial frequency mask corresponding to the spatial frequency mask whose mask area has been enlarged by rotating the spatial frequency mask whose mask area has been enlarged. However, the method of generating the corrected spatial frequency mask is not limited to this. For example, the mask area of the spatial frequency mask does not necessarily need to be enlarged and it may also be possible for the corrected mask generation unit 1213 to rotate the spatial frequency mask generated by the mask generation unit 211.

According to the image processing apparatus 100 configured as above, even in a case where there are variations in the direction of the texture pattern, it is possible to easily reduce the texture pattern from an image without the need to perform complicated work. Particularly, by generating in advance a plurality of corrected spatial frequency masks and using the corrected spatial frequency mask in a case where the target spatial frequency component in the plurality of corrected spatial frequency masks is reduced, it is possible to reduce the amount of calculation necessary for calculating a correlation coefficient. Further, in a case where the reduced target image is generated continuously for a plurality of pieces of target image data corresponding to a plurality of inspection-target products different from one another, it is recommended to store the data of each corrected spatial frequency mask generated at S1304 in the auxiliary storage device 304 or the like. Due to this, it is possible to omit the processing to generate a plurality of corrected spatial frequency masks for each inspection-target product.

There are a case where the mask areas of the spatial frequency mask distribute widely toward the direction of the origin of the frequency map and a case where the mask areas of the spatial frequency mask distribute widely in the direction perpendicular to the direction toward the direction of the origin of the frequency map. In the former case, it is necessary to reduce the interval of the angle by which the spatial frequency mask is rotated. In contrast to this, in the latter case, even though the interval of the angle by which the spatial frequency mask is rotated is increased by a certain amount compared to the former case, it is possible to perform the reduction of the target spatial frequency component with high accuracy. Consequently, it is preferred to determine the interval of the angle by which the spatial frequency mask is rotated in accordance with the distribution characteristic of the mask area of the spatial frequency mask. Further, in the present embodiment, as in Embodiment 1, the aspect is explained in which the texture pattern in the target image is reduced, which is formed intentionally, but it is also possible to apply the image processing apparatus 100 to the reduction of the texture pattern included in an image as noise.

### Embodiment 3

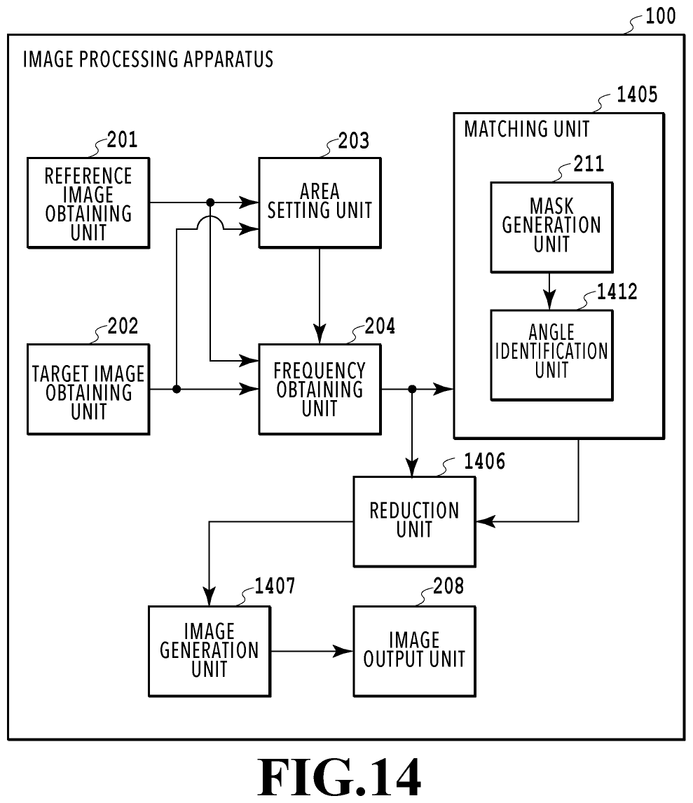

With reference to FIG. 14 to FIG. 16B, the image processing apparatus 100 according to Embodiment 3 is explained. The image processing apparatus 100 according to Embodiment 1 rotates the spatial frequency mask in a case where the position of the area of the target spatial frequency component is matched with the position of the mask area of the spatial frequency mask, on the frequency map. In contrast to this, the image processing apparatus 100 according to Embodiment 3 rotates the target spatial frequency component on the frequency map, in a case where the area of the target spatial frequency component is matched with the mask area of the spatial frequency mask.

FIG. 14 is a block diagram showing one example of the function configuration of the image processing apparatus 100 (in the following, simply described as “image processing apparatus 100”) according to Embodiment 3. In FIG. 14, to the same configuration as the function configuration shown in FIG. 2 or FIG. 12, the same symbol is attached and explanation is omitted. The image processing apparatus 100 comprises the reference image obtaining unit 201, the target image obtaining unit 202, the area setting unit 203, the frequency obtaining unit 204, a matching unit 1405, a reduction unit 1406, an image generation unit 1407, and the image output unit 208. Further, the matching unit 1405 comprises the mask generation unit 211 and an angle identification unit 1412. The processing of each unit the image processing apparatus 100 comprises as the function configuration is performed by hardware, such as an ASIC and an FPGA, which is incorporated in the image processing apparatus 100. Further, the processing may be performed by software using a memory, such as a RAM, and a processor, such as a CPU. In the following, explanation is given on the assumption that the image processing apparatus 100 includes the computer shown in FIG. 3 as one example and each unit the image processing apparatus 100 comprises as the function configuration operates as software.

The matching unit 1405 matches the reference spatial frequency component with the target spatial frequency component. Specifically, the mask generation unit 211 generates a spatial frequency mask. The angle identification unit 1412 identifies the rotation amount of the target spatial frequency component, which maximizes the correlation coefficient between the area of the target spatial frequency component and the mask area of the spatial frequency mask, by rotating the target spatial frequency component on the frequency map. The angle identification unit 1412 causes the auxiliary storage device 304 or the like to store the information indicating the identified rotation amount. The reduction unit 1406 reduces the target spatial frequency component in the rotated spatial frequency distribution by using the spatial frequency mask by rotating the spatial frequency distribution for each micro target image based on the rotation amount identified by the angle identification unit 1412. It is desirable for the size of the micro image area to be determined based on the size of the mask area in the spatial frequency mask.

The image generation unit 1407 generates a reduced target image by using the spatial frequency distribution after the target spatial frequency component is reduced for each micro target image. Specifically, first, the image generation unit 1407 rotates the spatial frequency distribution after the target spatial frequency component is reduced for each micro target image in the direction opposite to the rotation direction of the reduction unit 1406 based on the rotation amount identified by the angle identification unit 1412. Next, the image generation unit 1407 generates a micro target image after the target texture pattern is reduced by performing inverse transform processing, such as inverse fast Fourier transform, for the spatial frequency distribution rotated in the opposite direction after the target spatial frequency component is reduced for each micro target image. Further, the image generation unit 1407 generates a target image after the target texture pattern is reduced (reduced target image) by composing the micro target image after the target texture pattern is reduced, which is generated for each micro target image. The image output unit 208 outputs the data of the reduced target image (reduced target image data) generated by the image generation unit 1407 to the auxiliary storage device 304, the inspection apparatus 120 or the like.

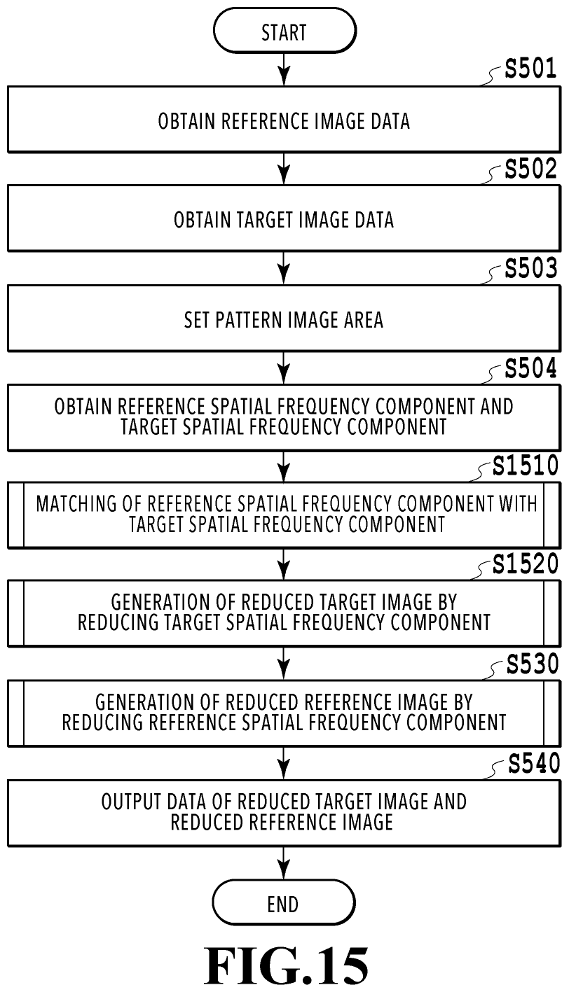

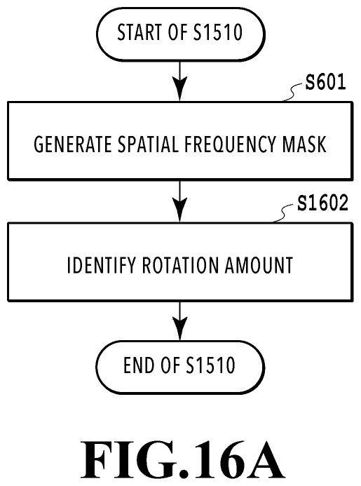

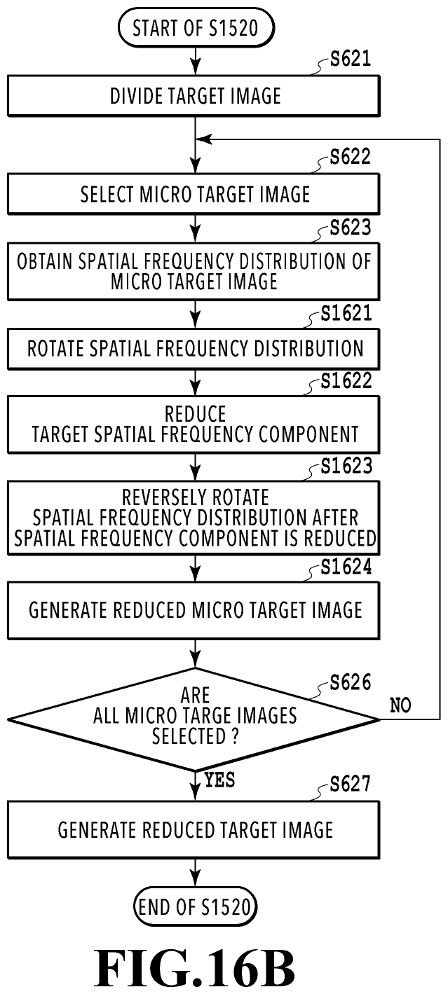

With reference to FIG. 15, FIG. 16A, and FIG. 16B, the operation of the image processing apparatus 100 is explained. FIG. 15 is a flowchart showing one example of a processing flow of the image processing apparatus 100 according to Embodiment 3. In FIG. 15, to the same processing as the processing shown in FIG. 5, the same symbol is attached and explanation is omitted. First, the image processing apparatus 100 performs the processing at S501 to S504. After S504, at S1510, the matching unit 1405 matches the reference spatial frequency component with the target spatial frequency component.

With reference to FIG. 16A, the processing at S1510 shown in FIG. 15 is explained. FIG. 16A is a flowchart showing one example of a processing flow in the matching unit 1405 according to Embodiment 3. The flowchart shown in FIG. 16A is performed as the processing at S1510 shown in FIG. 15 starts. Further, in FIG. 16A, to the same processing as the processing shown in FIG. 6A, the same symbol is attached and explanation is omitted. First, the matching unit 1405 performs the processing at S601. After S601, at S1602, the angle identification unit 1412 identifies the rotation amount of the target spatial frequency component, which maximizes the correlation coefficient between the area of the target spatial frequency component and the mask area of the spatial frequency mask, by rotating the target spatial frequency component on the frequency map. The information indicating the rotation amount identified at S1602 is stored in the RAM 303, the auxiliary storage device 304 or the like. After S1602, the matching unit 1405 terminates the processing of the flowchart shown in FIG. 16A. After S1510, at S1520, the image processing apparatus 100 generates a reduced target image by reducing the target spatial frequency component in the spatial frequency distribution of the target image. The processing at S1520 is performed by the frequency obtaining unit 204, the reduction unit 1406, and the image generation unit 1407.

With reference to FIG. 16B, the processing at S1520 is explained. FIG. 16B is a flowchart showing one example of a processing flow in the processing at S1520 shown in FIG. 15. The flowchart shown in FIG. 16B is performed as the processing at S1520 shown in FIG. 15 starts. Further, in FIG. 16B, to the same processing as the processing shown in FIG. 6B, the same symbol is attached and explanation is omitted. First, the image processing apparatus 100 performs the processing at S621 to S623. In Embodiment 3, the size of the micro image area is determined based on the size of the mask area in the spatial frequency mask generated at S601. After S623, at S1621, the reduction unit 1406 rotates the spatial frequency distribution of the micro target image on the frequency map by using the rotation amount identified at S602. Next, at S1622, the reduction unit 1406 reduces the target spatial frequency component in the rotated spatial frequency distribution of the micro target image by using the spatial frequency mask generated at S601.

Next, at S1623, the image generation unit 1407 reversely rotates the rotated spatial frequency distribution after the target spatial frequency component is reduced in the micro target image on the frequency map by using the rotation amount identified at S602. Next, at S1624, the image generation unit 1407 generates an image after the target texture pattern in the micro target image is reduced (reduced micro target image) by using the reversely rotated spatial frequency distribution after the target spatial frequency component is reduced in the micro target image. After S1624, the image processing apparatus 100 appropriately performs the processing at S626 and S627 and after S627, the image processing apparatus 100 terminates the processing of the flowchart shown in FIG. 16B. After S1520, the image processing apparatus 100 performs the processing at S530 and S540 and after S540, the image processing apparatus 100 terminates the processing of the flowchart shown in FIG. 15.

According to the image processing apparatus 100 configured as above, even in a case where there are variations in the direction of the texture pattern, it is possible to easily reduce the texture pattern from an image without the need to perform complicated work. In a case where the reduced target image is generated continuously for a plurality of pieces of target image data corresponding to a plurality of inspection-target products different from one another, it is recommended to store the data of the spatial frequency mask generated at S601 in the auxiliary storage device 304 or the like. Due to this, it is no longer necessary to perform the series of processing for generating a spatial frequency mask for each piece of target image data. Further, in this case, it is also recommended to store the data of the reduced reference image generated at S530 in the auxiliary storage device 304 or the like. Due to this, it is no longer necessary to perform the series of processing for generating a reduced reference image for each piece of target image data. Further, in the present embodiment, as in Embodiment 1, the aspect is explained in which the texture pattern in the target image, which is formed intentionally, is reduced, but it is also possible to apply the image processing apparatus 100 to the reduction of the texture pattern included in an image as noise.

### Embodiment 4

In Embodiment 1 to Embodiment 3, the reduction processing of the texture pattern in a case where one texture pattern is distributed uniformly in the entire area or the like of the surface of the inspection-target product is explained. In Embodiment 4, reduction processing of each texture pattern in a case where texture patterns different from one another are distributed in two or more partial areas in a plurality of partial areas on the surface or the like of an inspection-target product is explained.

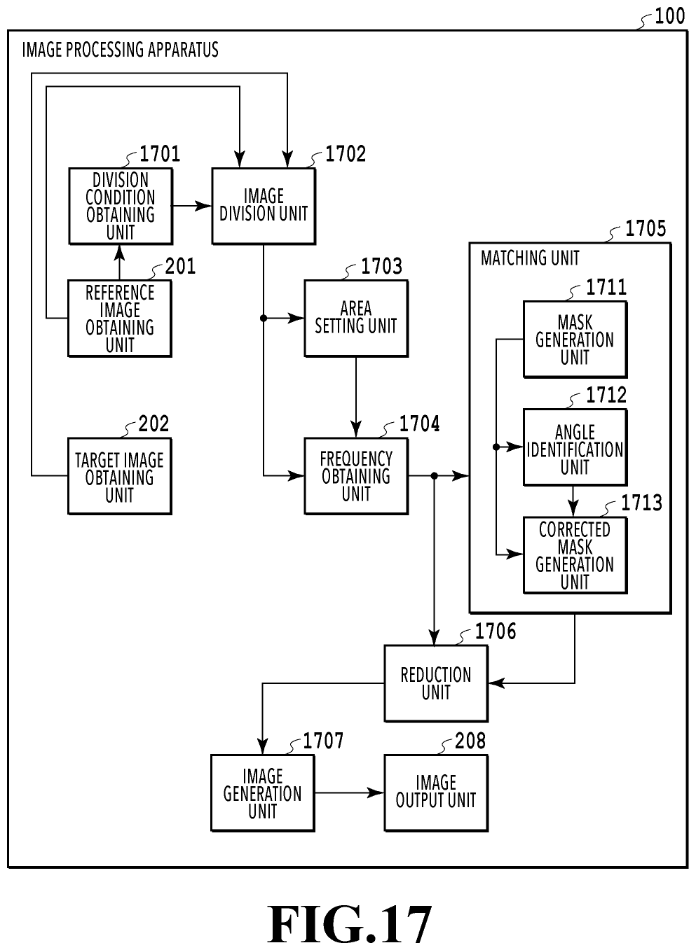

FIG. 17 is a block diagram showing one example of the function configuration of the image processing apparatus 100 (in the following, simply described as “image processing apparatus 100”) according to Embodiment 4. In FIG. 17, to the same configuration as the function configuration shown in FIG. 2, FIG. 12, or FIG. 14, the same symbol is attached and explanation is omitted. The image processing apparatus 100 comprises the reference image obtaining unit 201, the target image obtaining unit 202, a division condition obtaining unit 1701, an image division unit 1702, an area setting unit 1703, a frequency obtaining unit 1704, a matching unit 1705, a reduction unit 1706, an image generation unit 1707, and the image output unit 208. Further, the matching unit 1705 comprises a mask generation unit 1711, an angle identification unit 1712, and a corrected mask generation unit 1713. The processing of each unit the image processing apparatus 100 comprises as the function configuration is performed by hardware, such as an ASIC or an FPGA, which is incorporated in the image processing apparatus 100. Further, the processing may be performed by software using a memory, such as a RAM, and a processor, such as a CPU. In the following, explanation is given on the assumption that the image processing apparatus 100 includes the computer shown in FIG. 3 as one example and each unit the image processing apparatus 100 comprises as the function configuration operates as software.

The division condition obtaining unit 1701 obtains information (in the following, called “division condition information”) indicating area division conditions for dividing the reference image and the target image for each texture pattern. For example, the division condition obtaining unit 1701 analyzes the texture pattern included in each of the reference image and the target image by performing image analysis for each of the reference image and the target image. Due to this, the division condition obtaining unit 1701 identifies the image area corresponding to each of the texture patterns different from one another, which are included in the reference image, and the image area corresponding to each of the texture patterns different from one another, which are included in the target image, for each texture pattern. Further, the division condition obtaining unit 1701 obtains the division condition information by determining the area division conditions for dividing the reference image and the target image for each of the texture patterns included in the reference image and the target image based on the results of the identification. The division condition obtaining unit 1701 causes the auxiliary storage device 304 or the like to store the obtained division condition information.

Here, the above-described identification of the image area by the image analysis may identify the boundary between image areas by the difference in, for example, such as the tint or the luminance of each image area, or may identify the boundary between image areas by the difference in the spatial frequency distribution of each image area. Further, the area division conditions indicated by the division condition information are not limited to those determined by the image analysis. For example, in a case of the inspection or the like of a specific product, it is possible to designate in advance the area division conditions of the reference image and the target image, which correspond to the product. Because of this, it may also be possible to create in advance the division condition information for each type of inspection-target product and the division condition obtaining unit 1701 may obtain the division condition information corresponding to the inspection-target product by reading it from the auxiliary storage device 304 or the like. The division condition information in this case only needs to be information with which it is possible to divide the reference image and the target image for each texture pattern. Specifically, for example, the division condition information may be data of the mask image, with which it is possible to extract the image area of each texture pattern by the mask processing for the reference image and the target image, information indicating the image area of each texture pattern, or the like. Further, for example, the division condition information may information indicating the spatial frequency component of each texture pattern in the reference image, data of the spatial frequency mask of each texture pattern in the reference image, or the like.

The image division unit 1702 divides the reference image and the target image so that the texture patterns in the divided image areas are different from one another based on the area division conditions indicated by the division condition information the division condition obtaining unit 1701 obtains. The image division unit 1702 causes the auxiliary storage device 304 or the like to store the data of the reference image (in the following, called “divided reference image”) corresponding to each divided image area and the data of the target image (in the following, called “divided target image”) corresponding to each divided image area.

The area setting unit 1703 sets the image area of the divided reference image for each divided reference image, which is used in a case where the spatial frequency component of the reference texture pattern (reference spatial frequency component) included in the divided reference image is obtained. Further, the area setting unit 1703 sets the image area of the divided target image for each divided target image, which is used in a case where the spatial frequency component of the target texture pattern (target spatial frequency component) included in the divided target image. The method of setting the image area of the divided reference image and the divided target image in the area setting unit 1703 is the same as the method of setting the image area of the reference image and the target image in the area setting unit 203 according to Embodiment 1, and therefore, explanation is omitted.

The frequency obtaining unit 1704 obtains a two-dimensional spatial frequency distribution in the image by using a frequency analysis method, such as fast Fourier transform. Specifically, the frequency obtaining unit 1704 obtains information indicating the spatial frequency component of the reference texture pattern (reference spatial frequency component) included in the divided reference image by obtaining the spatial frequency distribution of the divided reference image for each divided reference image. More specifically, the frequency obtaining unit 1704 obtains information indicating the reference spatial frequency component corresponding to each divided reference image by obtaining the spatial frequency distribution in the image area of the divided reference image, which is set by the area setting unit 1703 for each divided reference image.

Further, the frequency obtaining unit 1704 obtains information indicating the spatial frequency component of the target texture pattern (target spatial frequency component) included in the divided target image by obtaining the spatial frequency distribution of the divided target image for each divided target image. Specifically, the frequency obtaining unit 1704 obtains information indicating the target spatial frequency component corresponding to each divided target image by obtaining the spatial frequency component in the image area of the divided target image, which is set by the area setting unit 1703 for each divided target image. The method of obtaining the spatial frequency component of the texture pattern included in each divided reference image and each divided target image in the frequency obtaining unit 1704 is the same as the method of obtaining the spatial frequency component of the texture pattern included in the reference image and the target image in the frequency obtaining unit 204. Because of this, the explanation of the obtaining method is omitted.

Further, the frequency obtaining unit 1704 divides the divided target image into a plurality of micro image areas for each divided target image and obtains the spatial frequency distribution of the micro target image corresponding to each micro image area for each divided micro image area. Here, it is assumed that the frequency obtaining unit 1704 also divides the divided reference image into a plurality of micro image areas for each divided reference image for the reference image and obtains the spatial frequency distribution of the micro reference image corresponding to the divided micro image area. The method of dividing each divided reference image and each divided target image into the micro image areas in the frequency obtaining unit 1704 is the same as the method of dividing the reference image and the target image into the micro image areas in the frequency obtaining unit 204, and therefore, explanation is omitted. Further, the reference image is divided into the divided reference images for each image area corresponding to each texture pattern by the image division unit 1702, and therefore, it may also be possible for the frequency obtaining unit 1704 to perform the above-described processing by handling the divided reference images as one micro reference image. Similarly, the target image is divided into the divided target images for each image area corresponding to each texture pattern by the image division unit 1702, and therefore, it may also be possible for the frequency obtaining unit 1704 to perform the above-described processing by handling the divided target images as one micro target image.

The matching unit 1705 matches the reference spatial frequency component in the divided reference image with the target spatial frequency component in the divided target image corresponding to the image area of the divided reference image for each divided reference image. Specifically, the mask generation unit 1711 generates a spatial frequency mask for each divided reference image, which masks the area of the reference spatial frequency component in the divided reference image in a two-dimensional frequency map in a case where the spatial frequency distribution of the divided reference image is represented in the frequency map. The method of generating the spatial frequency mask of each divided reference image in the mask generation unit 1711 is the same as the method of generating the spatial frequency mask in the mask generation unit 211 according to Embodiment 1, and therefore, explanation is omitted.

The angle identification unit 1712 matches the area of the reference spatial frequency component in the divided reference image on the frequency map with the area of the target spatial frequency component in the divided target image corresponding to the divided reference image for each divided reference image. Due to this, the angle identification unit 1712 identifies the misalignment amount in angle between the reference spatial frequency component in the divided reference image on the frequency map and the target spatial frequency component in the divided target image corresponding to the divided reference image for each divided reference image. Specifically, the angle identification unit 1712 rotates the spatial frequency mask on the frequency map for each spatial frequency mask generated by the mask generation unit 1711. Further, the angle identification unit 1712 identifies the rotation amount of the spatial frequency mask, which maximizes the correlation coefficient by the rotation between the mask area of the spatial frequency mask and the area of the target spatial frequency component in the divided target image corresponding to the divided reference image, which corresponds to the spatial frequency mask. Due to this, the angle identification unit 1712 identifies the misalignment amount in angle between the reference spatial frequency component in the divided reference image and the target spatial frequency component in the divided target image corresponding to the divided reference image on the frequency map.

The corrected mask generation unit 1713 generates a corrected spatial frequency mask for each divided target image. Specifically, the corrected mask generation unit 1713 generates a corrected spatial frequency mask for masking the target spatial frequency component in the divided target image from the spatial frequency distribution of the divided target image by using the misalignment amount in angle identified for each divided reference image by the angle identification unit 1712. The method of generating the corrected spatial frequency mask corresponding to each divided target image in the corrected mask generation unit 1713 is the same as the method of generating the corrected spatial frequency mask in the corrected mask generation unit 213 according to Embodiment 1, and therefore, explanation is omitted.

The reduction unit 1706 reduces the target spatial frequency component in the spatial frequency distribution of the micro target image by the mask processing using the corrected spatial frequency mask of the divided target image corresponding to the micro target image for each micro target image. Here, it is assumed that for the micro reference image also, the reduction unit 1706 reduces the reference spatial frequency component in the spatial frequency distribution of the micro reference image by the mask processing using the spatial frequency mask of the divided reference image corresponding to the micro reference image for each micro reference image. The method of reducing the target spatial frequency component and the reference spatial frequency component in the reduction unit 1706 is the same as the method of reducing the target spatial frequency component and the reference spatial frequency component in the reduction unit 206 according to Embodiment 1, and therefore, explanation is omitted.

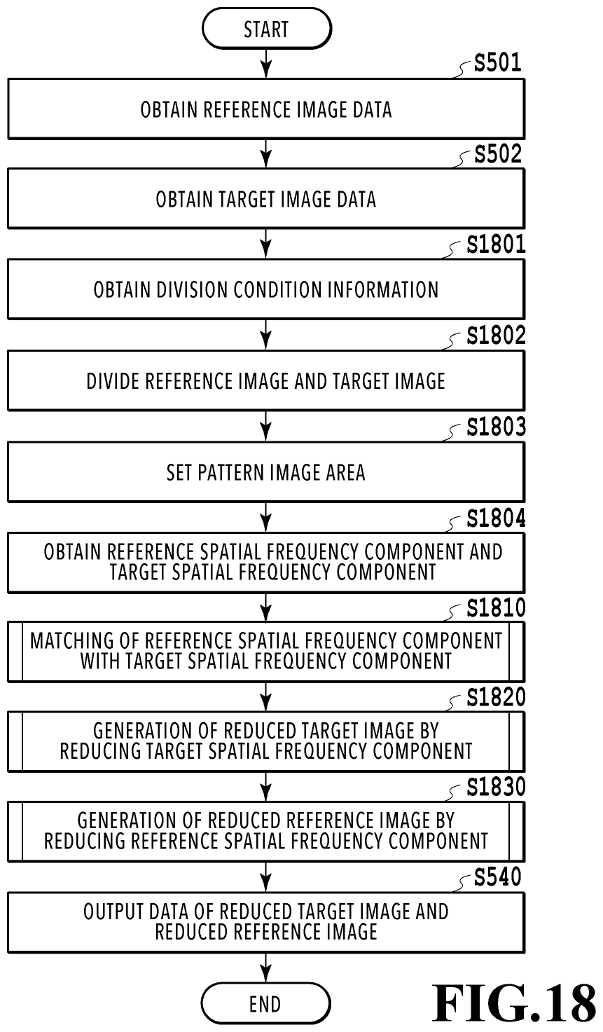

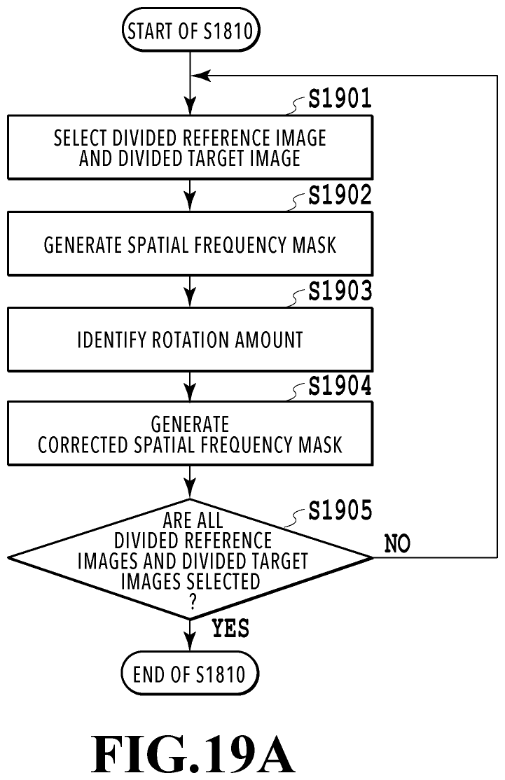

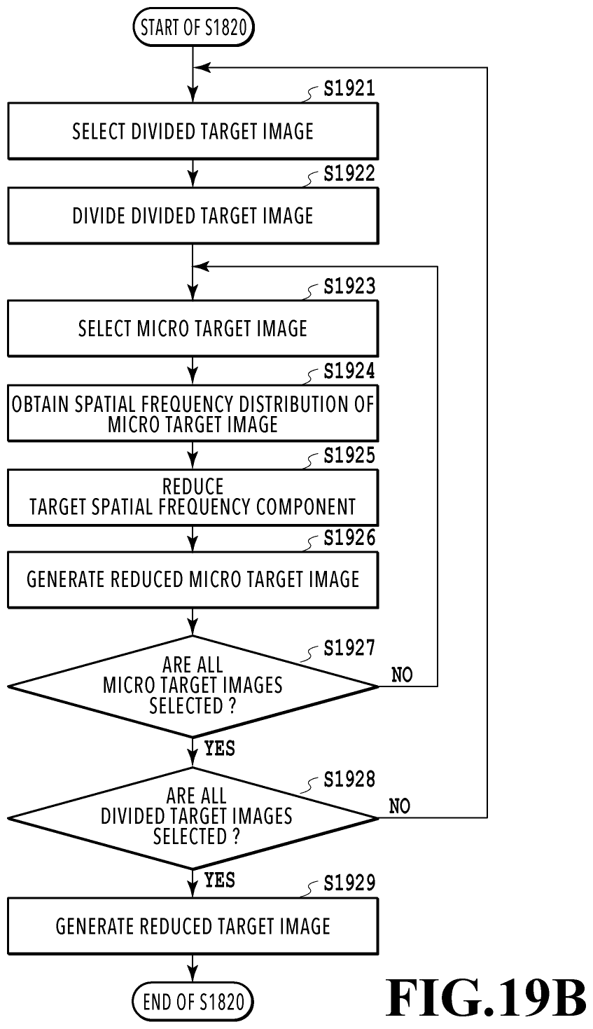

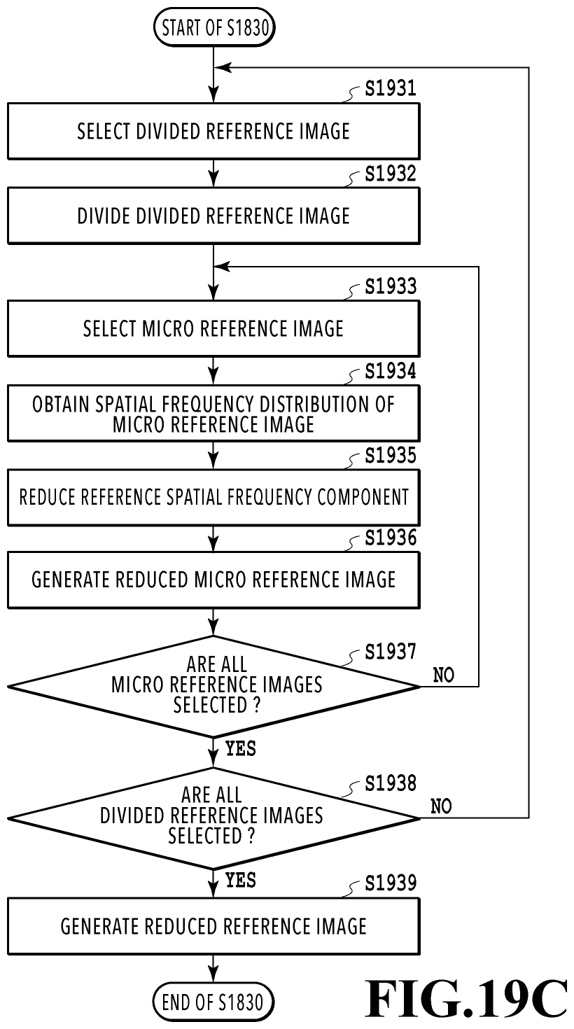

With reference to FIG. 18, FIG. 19A, FIG. 19B, and FIG. 19C, the operation of the image processing apparatus 100 is explained. FIG. 18 is a flowchart showing one example of a processing flow of the image processing apparatus 100 according to Embodiment 4. In FIG. 18, to the same processing as the processing in FIG. 5 or FIG. 13, the same symbol is attached and explanation is omitted. First, the image processing apparatus 100 performs the processing at S501 and S502. After S502, at S1801, the division condition obtaining unit 1701 obtains division condition information. For example, the division condition obtaining unit 1701 determines area division conditions for dividing the reference image and the target image by identifying the image area including texture patterns different from one another in the reference image and the target image by performing image analysis for the reference image and the target image. Due to this, the division condition obtaining unit 1701 obtains information indicating the area division conditions (division condition information). Next, at S1802, the image division unit 1702 divides each of the reference image and the target image into a plurality of image areas based on the division condition information obtained at S1801. Specifically, the image division unit 1702 divides the reference image into a plurality of divided reference images and divides the target image into a plurality of divided target images, based on the division condition information.

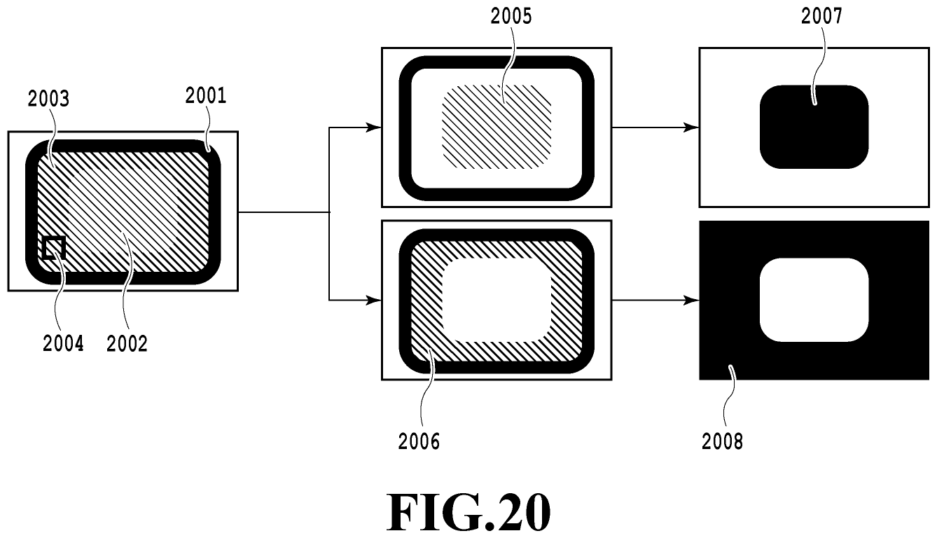

With reference to FIG. 20, the area division processing of the reference image is explained. FIG. 20 is an explanatory diagram for explaining one example of the area division processing of the reference image according to Embodiment 4. An image 2001 shows one example of the reference image. An area 2002 and an area 2003 are areas in which texture patterns different from each other are formed on the surface or the like of a product. The image 2001 is divided into an image including a divided area 2005 corresponding to the area 2002 and an image including a divided area 2006 corresponding to the area 2003 based on the division condition information. It may also be possible for the image division unit 1702 to generate an image area mask 2007 for masking the divided area 2005 and an image area mask 2008 for masking the divided area 2006. In this case, it is possible for the image division unit 1702 to divide the target image by using the image area masks 2007 and 2008. Performing the division of the target image using the image area masks 2007 and 2008 will obviate the determination processing of the area division conditions by the image analysis of the target image. A rectangular frame 2004 represents the image area that is used in a case where the reference spatial frequency component is extracted.

After S1802, at S1803, the area setting unit 1703 sets the pattern image area for each of the reference image and the target image. Specifically, the area setting unit 1703 sets the pattern image area for each divided reference image and sets the pattern image area for each divided target image. The method of setting the pattern image area is described above, and therefore, explanation is omitted. Next, at S1804, the frequency obtaining unit 1704 obtains, as regards all the divided reference images, information indicating the reference spatial frequency component of each divided reference image by obtaining the spatial frequency distribution in the pattern image area set for each divided reference image at S1803. Similarly, the frequency obtaining unit 1704 obtains, as regards all the divided target images, information indicating the target spatial frequency component of each divided target image by obtaining the spatial frequency distribution in the pattern image area set for each divided target image at S1803.

In the present embodiment, as one example, it is assumed that the pattern image area is set separately for the divided reference image and the divided target image as described above, but the method of setting the pattern image area is not limited to that described above. For example, it may also be possible for the area setting unit 1703 to set the pattern image area for each divided reference image and set the same pattern image area as the pattern image area set to the divided reference image corresponding to the divided target image as regards the pattern image area of the divided target image. In this case, it may happen that the pattern image area set to the divided reference image crosses the boarder into the area of another divided target image in the divided target image. Because of this, for example, in a case where the target image is divided by using the image area masks 2007 and 2008, it is desirable to correct the border of the mask area in the image area mask 2007 or 2008 as follows.

Specifically, first, the division condition obtaining unit 1701 identifies the border of the texture pattern in the target image by image analysis and following this, corrects the position of the mask area so that the border matches with the border of the mask area in the image area mask 2007 or 2008. Further, the division condition obtaining unit 1701 obtains the data of the corrected image area masks 2007 and 2008 as the division condition information on the target image. In this case, for example, the image division unit 1702 divides the target image into divided target images by using the corrected image area masks 2007 and 2008. Further, the area setting unit 1703 sets the pattern image area for each divided reference image and as regards the pattern image area of the divided target image, sets the same pattern image area as the pattern image area set to the divided reference image corresponding to the divided target image. By designing the configuration as described above, it is no longer necessary for a user to manually set the pattern image area for each divided target image.

After S1804, at S1810, the matching unit 1705 matches the reference spatial frequency component with the target spatial frequency component. With reference to FIG. 19A, the processing at S1810 shown in FIG. 18 is explained. FIG. 19A is a flowchart showing one example of a processing flow in the matching unit 1705 according to Embodiment 4. The flowchart shown in FIG. 19A is performed as the processing at S1810 shown in FIG. 18 starts. First, at S1901, the matching unit 1705 selects an arbitrary divided reference image from among the plurality of divided reference images divided at S1802 and further, selects the divided target image corresponding to the selected divided reference image. Next, at S1902, the mask generation unit 1711 generates a spatial frequency mask that masks the area corresponding to the reference spatial frequency component on the frequency map based on the reference spatial frequency component corresponding to the divided reference image selected at S1901.

Next, at S1903, the angle identification unit 1712 identifies the rotation amount on the frequency map of the spatial frequency mask, by which the area of the target spatial frequency component corresponding to the divided target image selected at S1901 matches with the mask area of the spatial frequency mask generated at S1902. Specifically, the angle identification unit 1712 rotates the spatial frequency mask and identifies the rotation amount of the spatial frequency mask, which maximizes the correlation coefficient between the area of the target spatial frequency component and the mask area of the spatial frequency mask. Next, at S1904, the corrected mask generation unit 1713 generates a corrected spatial frequency mask for masking the area of the target spatial frequency component from the spatial frequency distribution of the divided target image selected at S1901 by using the rotated spatial frequency mask. The data of the corrected spatial frequency mask generated at S1904 is stored in the RAM 303, the auxiliary storage device 304 or the like in association with the divided target image.

Next, at S1905, the matching unit 1705 determines whether or not all the divided reference images and the divided target images are selected at S1901. In a case where it is determined that one or some of the divided reference images or the divided target images are not selected at S1905, the matching unit 1705 returns to the processing at S1901. After returning to the processing at S1901, the matching unit 1705 repeatedly performs the processing at S1901 to S1905 until it is determined that all the divided reference images and the divided target images are selected at S1905. In this case, the matching unit 1705 selects the divided reference image and the divided reference image that are not selected yet at S1901 and performs the processing at S1902 to S1905. In a case where it is determined that all the divided reference images and the divided target images are selected at S1905, the matching unit 1705 terminates the processing of the flowchart shown in FIG. 19A.

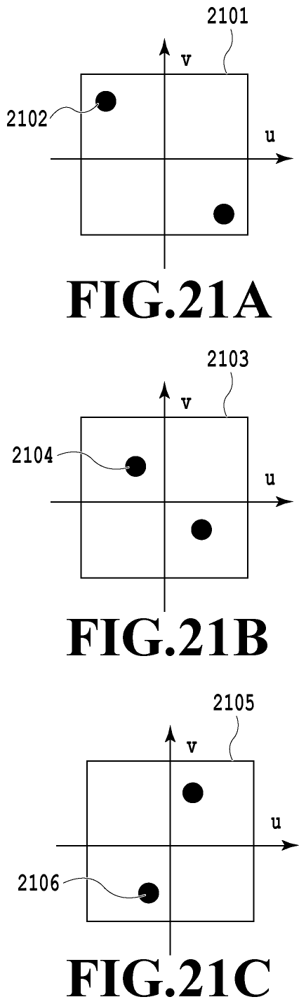

With reference to FIG. 21A to FIG. 21C, the spatial frequency mask the mask generation unit 1711 generates is explained. FIG. 21A to FIG. 21C are each a diagram showing one example of the spatial frequency mask the mask generation unit 1711 according to Embodiment 4 generates. Each of spatial frequency masks 2101, 2103, and 2105 shown in FIG. 21A, FIG. 21B, and FIG. 21C is a spatial frequency mask corresponding to a texture pattern included in three divided reference images different from one another. The spatial frequency masks 2101, 2103, and 2105 have mask areas 2102, 2104, and 2106, respectively, which correspond to three reference spatial frequency components, respectively, which are different from one another.

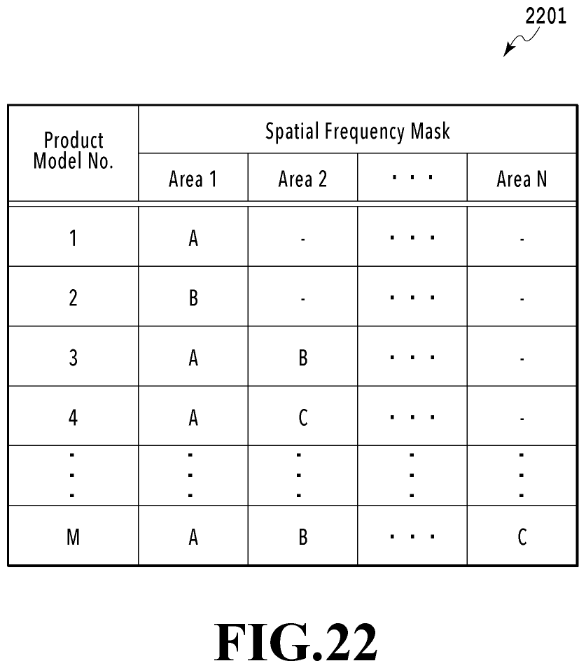

There is a case where the inspection system 1 randomly inspects a plurality of types of product having outer appearance specifications different from one another. In this case, it is necessary for the image processing apparatus 100 to perform processing to reduce the texture pattern in accordance with the model number of the inspection-target product by identifying the model number of the product. FIG. 22 is a correspondence table in which the model number of the product and the condition of the processing to reduce the texture pattern are associated with each other in a case where the processing to reduce the texture pattern is performed. The data of the correspondence table is stored in advance in the auxiliary storage device 304 or the like. For example, it may also be possible to store in advance information (division condition information) indicating the area division conditions of the texture pattern formed on the surface or the like of the product corresponding to the model number and the data of one or more spatial frequency masks corresponding to the division condition information in the auxiliary storage device 304 or the like for each model number of the product. In this case, for example, the image processing apparatus 100 identifies the model number of the inspection-target product and obtains the division condition information on the texture pattern corresponding to the identified model number and the data of the spatial frequency mask corresponding to the division condition information by reading them from the auxiliary storage device 304 or the like. Further, the image processing apparatus 100 generates a corrected spatial frequency mask by using the obtained spatial frequency mask.

After S1810, at S1820, the image processing apparatus 100 generates a reduced target image by reducing the target spatial frequency component in the spatial frequency distribution of the target image. The processing at S1802 is performed by the frequency obtaining unit 1704, the reduction unit 1706, and the image generation unit 1707. With reference to FIG. 19B, the processing at S1820 is explained. FIG. 19B is a flowchart showing one example of a processing flow in the processing at S1820 shown in FIG. 18. The flowchart shown in FIG. 19B is performed as the processing at S1820 shown in FIG. 18 starts.

First, at S1921, the frequency obtaining unit 1704 selects an arbitrary divided target image from among the plurality of divided target images divided at S1802. Next, at S1922, the frequency obtaining unit 1704 divides the divided target image selected at S1921 into a plurality of micro target images. Here, the size of the micro image area is determined based on, for example, the size of the mask area in the corrected spatial frequency mask corresponding to the divided target image selected at S1921 from among the plurality of corrected spatial frequency masks generated at S1904. Next, at S1923, the frequency obtaining unit 1704 selects an arbitrary micro target image from among the plurality of micro target images divided at S1922. Next, at S1924, the frequency obtaining unit 1704 obtains the spatial frequency distribution of the micro target image selected at S1923.

Next, at S1925, the reduction unit 1706 performs mask processing using the corrected spatial frequency mask corresponding to the divided target image selected at S1921 from among the plurality of corrected spatial frequency masks generated at S1904. Due to this, the reduction unit 1706 reduces the target spatial frequency component corresponding to the divided target image selected at S1921 from the spatial frequency distribution of the micro target image selected at S1923. Next, at S1926, the image generation unit 1707 generates an image in which the target texture pattern in the micro target image is reduced (reduced micro target image) by using the spatial frequency distribution after the target spatial frequency component is reduced in the micro target image selected at S1923.

Next, at S1927, the frequency obtaining unit 1704 determines whether or not all the micro target images are selected at S1923. In case where it is determined that one or some of the micro target images are not selected at S1927, the image processing apparatus 100 returns to the processing at S1923. After returning to the processing at S1923, the image processing apparatus 100 repeatedly performs the processing at S1923 to S1927 until it is determined that all the micro target images are selected at S1927. In this case, at S1923, the image processing apparatus 100 selects the micro target image that is not selected yet and performs the processing at S1924 to S1927. In a case where it is determined that all the micro target images are selected at S1927, the frequency obtaining unit 1704 determines, at S1928, whether or not all the divided target images are selected at S1921.

In a case where it is determined that one or some of the divided target images are not selected at S1928, the image processing apparatus 100 returns to the processing at S1921. After returning to the processing at S1921, the image processing apparatus 100 repeatedly performs the processing at S1921 to S1928 until it is determined that all the divided target images are selected at S1928. In the case, at S1921, the image processing apparatus 100 selects the divided target image that is not selected yet and performs the processing at S1922 to S1928. In a case where it is determined that all the divided target images are selected at S1928, the image generation unit 1707 generates, at S1929, a reduced target image by composing the plurality of reduced micro target images generated at S1926. After S1929, the image processing apparatus 100 terminates the processing of the flowchart shown in FIG. 19B.

After S1820, at S1830, the image processing apparatus 100 generates a reduced reference image by reducing the reference spatial frequency component in the spatial frequency distribution of the reference image. The processing at S1830 is performed by the frequency obtaining unit 1704, the reduction unit 1706, and the image generation unit 1707. With reference to FIG. 19C, the processing at S1830 is explained. FIG. 19C is a flowchart showing one example of a processing flow in the processing at S1830 shown in FIG. 18. The flowchart shown in FIG. 19C is performed as the processing at S1830 shown in FIG. 18 starts.

First, at S1931, the frequency obtaining unit 1704 selects an arbitrary divided reference image from the plurality of divided reference images divided at S1802. Next, at S1932, the frequency obtaining unit 1704 divides the divided reference image selected at S1931 into a plurality of micro reference images. Here, the size of the micro image area is determined based on, for example, the size of the mask area in the spatial frequency mask corresponding to the divided reference image selected at S1931 among the plurality of spatial frequency masks generated at S1902. Next, at S1933, the frequency obtaining unit 1704 selects an arbitrary micro reference image from among the plurality of micro reference images divided at S1932. Next, at S1934, the frequency obtaining unit 1704 obtains the spatial frequency distribution of the micro reference image selected at S1933.

Next, at S1935, the reduction unit 1706 performs mask processing using the spatial frequency mask corresponding to the divided reference image selected at S1931 among the plurality of spatial frequency masks generated at S1902. Due to this, the reduction unit 1706 reduces the reference spatial frequency component corresponding to the divided reference image selected at S1931 from the spatial frequency distribution of the micro reference image selected at S1933. Next, at S1936, the image generation unit 1707 generates an image in which the reference texture pattern in the micro reference image is reduced (reduced micro reference image) by using the spatial frequency distribution after the reference spatial frequency component is reduced in the micro reference image selected at S1933.

Next, at S1937, the frequency obtaining unit 1704 determines whether or not all the micro reference images are selected at S1933. In a case where it is determined that one or some of the micro reference images are not selected at S1937, the image processing apparatus 100 returns to the processing at S1933. After returning to the processing at S1933, the image processing apparatus 100 repeatedly performs the processing at S1933 to S1937 until it is determined that all the micro reference images are selected at S1937. In this case, the image processing apparatus 100 selects the micro reference image that is not selected yet and performs the processing at S1934 to S1937. In a case where it is determined that all the micro reference images are selected at S1937, the frequency obtaining unit 1704 determines, at S1938, whether or not all the divided reference images are selected at S1931.

In a case where it is determined that one or some of the divided reference images are not selected at S1938, the image processing apparatus 100 returns to the processing at S1931. After returning to the processing at S1931, the image processing apparatus 100 repeatedly performs the processing at S1931 to S1938 until it is determined that all the divided reference images are selected at S1938. In this case, at S1931, the image processing apparatus 100 selects the divided reference image that is not selected yet and performs the processing at S1932 to S1938. In a case where it is determined that all the divided reference images are selected at S1938, the image generation unit 1707 generates, at S1939, a reduced reference image by composing the plurality of reduced micro reference images generated at S1936. After S1939, the image processing apparatus 100 terminates the processing of the flowchart shown in FIG. 19C. After S1830, at S540, the image output unit 208 outputs the data of the reduced target image generated at S1820 and the data of the reduced reference image generated at S1830. After S540, the image processing apparatus 100 terminates the processing of the flowchart shown in FIG. 18.

According to the image processing apparatus 100 configured as above, even in a case where there are variations in the direction of the texture pattern, it is possible to easily reduce the texture pattern from an image without the need to perform complicated work. Particularly, according to the image processing apparatus 100 configured as above, even in a case where texture patterns different from one another for each partial area are combined and formed on the surface or the like of a product, it is possible to easily reduce the texture pattern from an image.

In a case where the reduced target image is generated continuously for a plurality of pieces of target image data corresponding to a plurality of inspection-target products different from one another, it is recommended to store the data of the spatial frequency mask generated at S1902 in the auxiliary storage device 304 or the like. Due to this, it is no longer necessary to perform the series of processing for generating a spatial frequency mask for each piece of target image data. Further, in this case, it is also recommended to store the data of the reduced reference image generated at S1830 in the auxiliary storage device 304 or the like. Due to this, it is no longer necessary to perform the series of processing for generating a reduced reference image for each piece of target image data. Further, in the present embodiment, as in Embodiment 1, the aspect is explained in which the texture pattern in the target image is reduced, which is formed intentionally, but it is also possible to apply the image processing apparatus 100 to the reduction of the texture pattern included in an image as noise.

### Embodiment 5

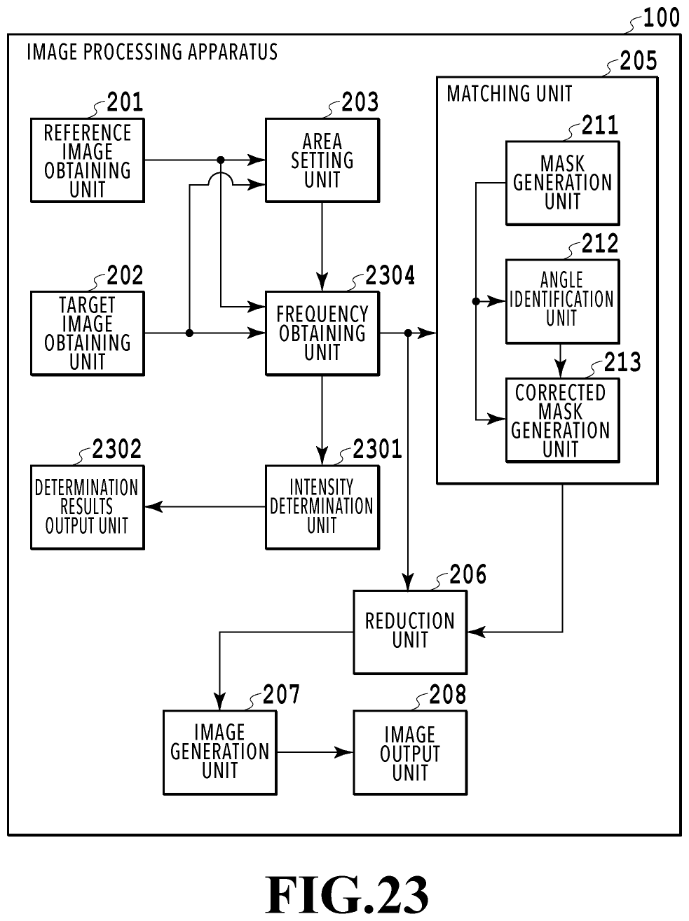

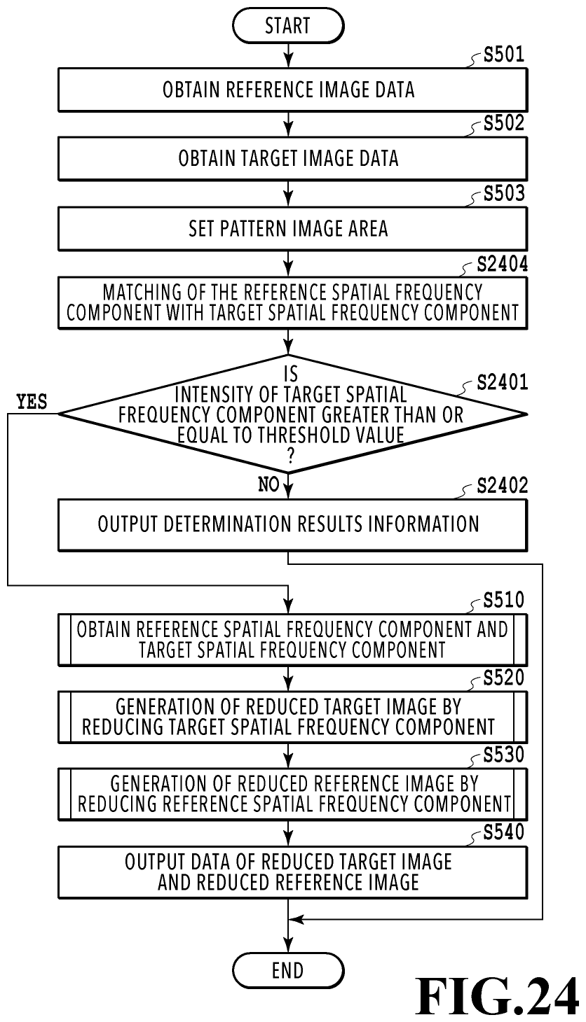

With reference to FIG. 23 and FIG. 24, the image processing apparatus 100 (in the following, simply described as “image processing apparatus 100”) according to Embodiment 5 is explained. As processing to form a texture pattern on the surface or the like of a product, for example, there is stamp processing to press a die or the like on which there are concavities and convexities corresponding to a texture pattern onto the surface of a product. In a case of the stamp processing, due to the lack of pressure in a case where the die or the like is pressed, or the sticking of the surface material of the product to the surface with concavities and convexities on the die or the like, there is a possibility that the vividness of the texture pattern that is formed on the surface or the like of the product is lost and as a result, there occurs a defect on the outer appearance of the product. Consequently, in Embodiment 5, an aspect is explained in which the vividness of a texture pattern formed on the surface or the like of an inspection-target product is evaluated before the reduction processing of the target texture pattern is performed. Specifically, after evaluating the vividness of the texture pattern formed on the surface or the like of the inspection-target product, the image processing apparatus 100 determines whether or not to generate a reduced target image in which the target texture pattern in the target image corresponding to the product is reduced based on the results of the evaluation. The reason is that in a case where the texture pattern is not vivid, it is supposed that there is a defect on the outer appearance of the product without the need to perform inspection using the reduced target image.

FIG. 23 is a block diagram showing one example of the function configuration of the image processing apparatus 100 according to Embodiment 5. The image processing apparatus 100 comprises the reference image obtaining unit 201, the target image obtaining unit 202, the area setting unit 203, a frequency obtaining unit 2304, an intensity determination unit 2301, a determination results output unit 2302, the matching unit 205, the reduction unit 206, the image generation unit 207, and the image output unit 208. Further, the matching unit 205 comprises the mask generation unit 211, the angle identification unit 212, and the corrected mask generation unit 213. In FIG. 23, to the same configuration as the function configuration shown in FIG. 2, FIG. 14, or FIG. 17, the same symbol is attached and explanation is omitted.

The processing of each unit the image processing apparatus 100 comprises as the function configuration is performed by hardware, such as an ASIC or an FPGA, which is incorporated in the image processing apparatus 100. Further, the processing may be performed by software using a memory, such as a RAM, and a processor, such as a CPU. In the following, explanation is given on the assumption that the image processing apparatus 100 includes the computer shown in FIG. 3 as one example and each unit the image processing apparatus 100 comprises as the function configuration operates as software. In the present embodiment, an aspect is explained in which the image processing apparatus 100 according to Embodiment 1 is deformed, but the image processing apparatus 100 may be the image processing apparatus 100 according to any one of Embodiment 2 to Embodiment 4, which is deformed.

The frequency obtaining unit 2304 also has a function to obtain information indicating the intensity of the target spatial frequency component, in addition to the function the frequency obtaining unit 204 according to Embodiment 1 has. Specifically, the frequency obtaining unit 2304 obtains the intensity of the target spatial frequency component in a case where the target spatial frequency component is obtained in the pattern image area of the target image, which is set by the area setting unit 203. For example, first, the frequency obtaining unit 2304 divides the pattern image area of the target image into a plurality of image areas and obtains the intensity of the target texture pattern for each divided image area. Following the above, the frequency obtaining unit 2304 calculates the statistic, such as the mean, the maximum, or the median, of the intensity obtained for each divided image area and obtains the statistic as information indicating the intensity of the target spatial frequency component. The method of obtaining the intensity of the target spatial frequency component is not limited to the that described above and the intensity of the target spatial frequency component may be any one that is in correlation with the vividness of the target texture pattern.

The intensity determination unit 2301 determines whether or not the intensity of the target spatial frequency component is greater than or equal to a predetermined threshold value. The determination results output unit 2302 outputs information (in the following, called “determination results information”) indicating the results of the determination by the intensity determination unit 2301. For example, in a case where it is determined that the intensity of the target spatial frequency component is not greater than or equal to the threshold value, that is, less than the threshold value by the intensity determination unit 2301, the determination results output unit 2302 outputs the determination results information to the inspection apparatus 120. In this case, for example, the inspection apparatus 120 obtains the determination results information and assumes that there is a defect in the inspection-target product corresponding to the target image based on the obtained determination results information, and generates a display image indicating that there is a defect in the inspection-target product and causes the display device to display the generated display image.

In a case where it is determined that the intensity of the target spatial frequency component is greater than or equal to the threshold value by the intensity determination unit 2301, the image processing apparatus 100 generates a reduced target image by performing processing to reduce the texture pattern included in the target image by the method shown in Embodiment as one example. In a case where it is determined that the intensity of the target spatial frequency component is not greater than or equal to the threshold value by the intensity determination unit 2301, the image processing apparatus 100 may omit the processing to reduce the texture pattern included in the target image. Further, in a case where it is determined that the intensity of the target spatial frequency component is greater than or equal to the threshold value by the intensity determination unit 2301, the determination results output unit 2302 may output or may not output the determination results information to the inspection apparatus 120.

With reference to FIG. 24, the operation of the image processing apparatus 100 is explained. FIG. 24 is a flowchart showing one example of a processing flow of the image processing apparatus 100 according to Embodiment 5. In FIG. 24, to the same processing as the processing shown in FIG. 5, FIG. 13, or FIG. 18, the same symbol is attached and explanation is omitted. First, the image processing apparatus 100 performs the processing at S501 to S503. After S503, at S2404, the frequency obtaining unit 2304 obtains information indicating the reference spatial frequency component, information indicating the target spatial frequency component, and information indicating the intensity of the target spatial frequency component. Next, at S2401, the intensity determination unit 2301 determines whether or not the intensity of the target spatial frequency component is greater than or equal to a threshold value. In a case where it is determined that the intensity of the target spatial frequency component is greater than or equal to the threshold value at S2401, the image processing apparatus 100 performs the processing at S510 to S540. In a case where it is determined that the intensity of the target spatial frequency component is not greater than or equal to the threshold value at S2401, the determination results output unit 2302 outputs the determination results information at 52402. After S540 or 52402, the image processing apparatus 100 terminates the processing of the flowchart shown in FIG. 24.

According to the image processing apparatus 100 configured as above, in a case where the intensity of a target spatial frequency component is less than a threshold value in inspection of an inspection-target product using a target image, it is possible to omit processing to reduce the texture pattern included in the target image.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present invention, it is possible to easily reduce the texture pattern from an image.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. An image processing apparatus comprising:
one or more processors; and
one or more memories storing one or more programs configured to be executed by the one or more processors, the one or more programs including instructions for:
matching a spatial frequency component of a first texture pattern taken to be a reference with a spatial frequency component of a second texture pattern included in a target image; and
reducing the spatial frequency component of the second texture pattern included in the target image based on results of the matching.

2. The image processing apparatus according to claim 1, wherein, by rotating the spatial frequency component of the first texture pattern or the spatial frequency component of the second texture pattern, the spatial frequency component of the first texture pattern is matched with the spatial frequency component of the second texture pattern.

3. The image processing apparatus according to claim 1, wherein the one or more programs further include instructions for:
generating a spatial frequency mask masking the spatial frequency component of the first texture pattern;
identifying a misalignment amount in angle between the mask area in the spatial frequency mask and a component area of the spatial frequency component of the second texture pattern; and
generating a corrected spatial frequency mask masking the spatial frequency component of the second texture pattern in a spatial frequency distribution in the target image based on the spatial frequency mask and the misalignment amount; and
by using the corrected spatial frequency mask, the spatial frequency component of the second texture pattern included in the target image is reduced.

4. The image processing apparatus according to claim 3, wherein the misalignment amount is identified by identifying a rotation amount of the spatial frequency mask, by which the mask area in the spatial frequency mask matches with the component area of the spatial frequency component of the second texture pattern, by rotating the spatial frequency mask.

5. The image processing apparatus according to claim 3, wherein the misalignment amount is identified by identifying a rotation amount of the component area, by which the mask area in the spatial frequency mask matches with the rotated component area, by rotating the component area of the spatial frequency component of the second texture pattern.

6. The image processing apparatus according to claim 1, wherein the one or more programs further include instructions for:
obtaining information on the spatial frequency component of the first texture pattern, information on the spatial frequency distribution in the target image, and information on the spatial frequency component of the second texture pattern; and
generating a reduced target image by reducing the second texture pattern included in the target image based on the spatial frequency distribution after the spatial frequency component of the second texture pattern is reduced.

7. The image processing apparatus according to claim 6, wherein the information on the spatial frequency component of the second texture pattern includes information indicating an intensity of the spatial frequency component of the second texture pattern.

8. The image processing apparatus according to claim 7, wherein the one or more programs further include an instruction for:
determining whether or not the intensity of the spatial frequency component of the second texture pattern is greater than or equal to a predetermined threshold value; and
in a case where the intensity is less than the threshold value, a series processing to generate the reduced target image is performed.

9. The image processing apparatus according to claim 6, wherein the one or more programs further include an instruction for:
obtaining data of the target image; and
based on the target image data, the information on the spatial frequency distribution of the target image and the information on the spatial frequency component of the second texture pattern are obtained.

10. The image processing apparatus according to claim 6, wherein the one or more programs further include an instruction for:
setting an image area of the target image, which is used to obtain the information on the spatial frequency component of the second texture pattern; and
the information on the spatial frequency component of the second texture pattern included in the set image area of the target image is obtained.

11. The image processing apparatus according to claim 6, wherein the one or more programs further include an instruction for:
obtaining data of a reference image including the first texture pattern; and
based on the reference image data, the information on the spatial frequency component of the first texture pattern is obtained.

12. The image processing apparatus according to claim 11, wherein the one or more programs further include an instruction for:
setting an image area of the reference image, which is used to obtain the information on the spatial frequency component of the first texture pattern; and
the information on the spatial frequency component of the first texture pattern included in the set image area of the reference image is obtained.

13. The image processing apparatus according to claim 6, wherein the one or more programs further include an instruction for:
performing control to cause a display device to display the reduced target image.

14. The image processing apparatus according to claim 13, wherein control to cause the display device to display the reference image including the first texture pattern is performed.

15. The image processing apparatus according to claim 13, wherein control to cause the display device to display the information on the spatial frequency component of the first texture pattern and the information on the spatial frequency component of the second texture pattern is performed.

16. The image processing apparatus according to claim 13, wherein control to cause the display device to display results of the matching of the spatial frequency component of the first texture pattern with the spatial frequency component of the second texture pattern is performed.

17. The image processing apparatus according to claim 13, wherein control to cause the display device to display a parameter used for the matching of the spatial frequency component of the first texture pattern with the spatial frequency component of the second texture pattern and a graphical user interface used to set the parameter is performed.

18. The image processing apparatus according to claim 6, wherein the one or more programs further include an instruction for:
inspecting the presence/absence of a defect in an inspection-target object based on data of the reduced target image; and
the target image is the image obtained by capturing the inspection target object.

19. An image processing method comprising the steps of:
matching a spatial frequency component of a first texture pattern taken to be a reference with a spatial frequency component of a second texture pattern included in a target image; and
reducing the spatial frequency component of the second texture pattern included in the target image based on results of the matching.

20. A non-transitory computer readable storage medium storing a program for causing a computer to perform a control method of an image processing apparatus, the control method comprising the steps of:
matching a spatial frequency component of a first texture pattern taken to be a reference with a spatial frequency component of a second texture pattern included in a target image; and
reducing the spatial frequency component of the second texture pattern included in the target image based on results of the matching.
